(19) United States
(12) Patent Application Publication
(10) Pub. No.: US 2026/0253370 A1
(43) Pub. Date: Aug. 27, 2026

(54) SYSTEM

(71) Applicant: SoftBank Group Corp., Tokyo (JP)

(72) Inventor: Riho KAGEYAMA, Tokyo (JP)

(73) Assignee: SoftBank Group Corp., Tokyo (JP)

(21) Appl. No.: 19/537,672

(22) Filed: Feb. 12, 2026

(30) Foreign Application Priority Data
Feb. 21, 2025 (JP) 2025-027041

(51) Int. Cl. G06V 10/44; G06Q 30/0601; G06V 10/77; G06V 10/94

(52) U.S. Cl. CPC G06V 10/454; G06Q 30/0601; G06V 10/7715; G06V 10/95

(57) ABSTRACT

The system according to the embodiment comprises a receiving unit, a generation unit, and a providing unit. The receiving unit is configured to receive input of product features. The generation unit is configured to analyze information received by the receiving unit and generate a sales text for highlighting the appeal of the product. The providing unit is configured to provide the sales text generated by the generation unit to a user.

### CROSS-REFERENCE TO RELATED APPLICATION

The present application claims priority to and incorporates by reference the entire contents of Japanese Patent Application No. 2025-027041 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that users who are not professional sellers find it difficult to create attractive sales text, which requires time and effort.

### SUMMARY OF THE INVENTION

The system according to the embodiment comprises a receiving unit, a generation unit, and a providing unit. The receiving unit is configured to receive input of product features. The generation unit is configured to analyze information received by the receiving unit and generate a sales text for highlighting the appeal of the product. The providing unit is configured to provide the sales text generated by the generation unit to a user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

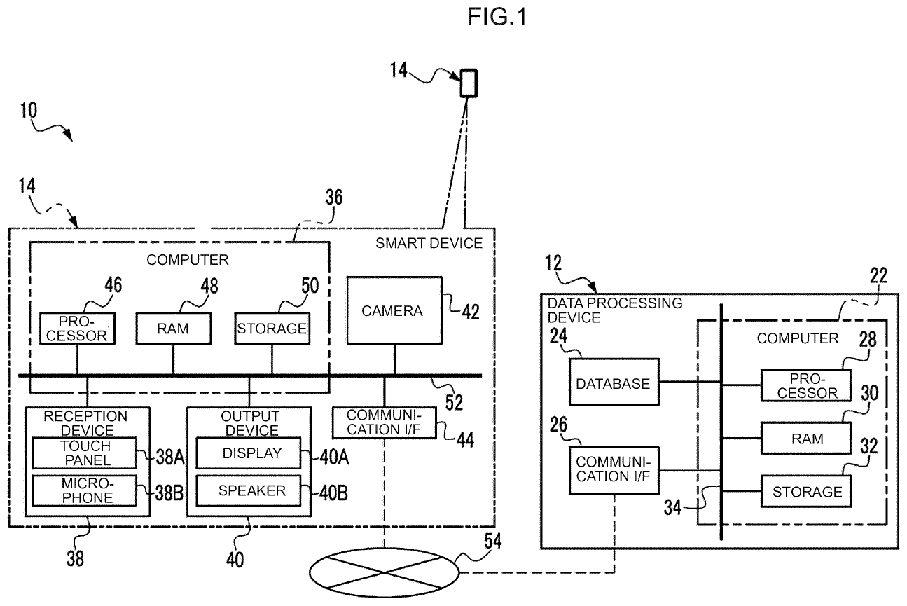

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

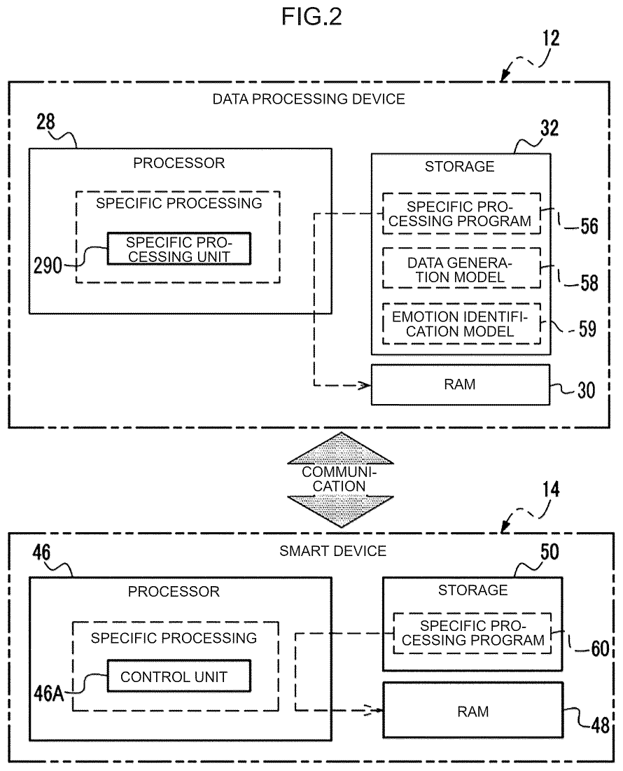

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE OF THE EMBODIMENT

The system according to the embodiment of the present invention is a system that automatically generates attractive sales text on merchandise platforms such as flea markets and auctions, simply by having non-professional users input product features. This system uses generative AI to accurately highlight the appeal of a product based on the features provided by the user, and provides original sales text tailored to each individual product. As a result, users can create effective product descriptions while saving time and effort. Furthermore, this system maximizes the effect of sales promotion, leading to increased sales and improved satisfaction for the platform provider. For example, a user inputs product features, such as brand name, condition, period of use, and distinctive points. This information is input to the generative AI. Next, the generative AI analyzes the input information and generates sales text to highlight the product's appeal. The generative AI generates attractive expressions and original sentences based on the product features. For example, it may generate sales text such as, “This product is the latest model from a famous brand and is in excellent condition as it has hardly been used. Furthermore, it is equipped with special features that set it apart from other products.” The generated sales text is provided to the user, who can review and make modifications as needed. This allows users to easily create attractive product descriptions. With this system, users can create effective product descriptions while saving time and effort, and the system maximizes sales promotion effects, resulting in increased sales and satisfaction for the platform provider. Thus, the system can automatically generate and provide attractive sales text simply by having users input product features. Specifically, the system is composed of multiple modules, such as a user interface section, feature extraction section, generative AI section, sales text optimization section, and output section. The system receives product feature information input by the user (e.g., brand name, condition, period of use, distinctive points as text data, image data, or audio data) via the receiving unit. The system vectorizes the information received by the receiving unit in the feature extraction section, converting, for example, brand name to one-hot encoding, condition to a categorical variable, period of use to a numerical scalar, and distinctive points to a TF-IDF vector or embedding vector, resulting in a multidimensional feature vector (e.g., 128 to 1024 dimensions). If image data is input, the system automatically extracts brand logos and product condition using image recognition models such as CNNs; if audio data is input, it converts it to text using speech recognition models. The system integrates these diverse feature vectors and inputs them to the generative AI section (e.g., a pre-trained large language model or encoder-decoder type Transformer). In the generative AI section, the system uses a model fine-tuned for the sales text generation task, conditioning on the input vectors, and sequentially generates the output token sequence for the sales text (e.g., up to 512 tokens). The system obtains the text sequence of the sales text (e.g., “This product is . . . ”) as output from the generative AI section, and in the sales text optimization section, calculates scores for diversity and originality of expression (e.g., BLEU score, self-attention weight distribution, similarity score), performing threshold judgment and regeneration processing as needed. The final sales text is presented to the user via the output section, and if the user makes modifications, those modifications are accumulated as retraining data. The system executes this series of processes at high speed on a parallel computing cluster using GPUs, achieving significant improvements in processing speed and accuracy compared to conventional manual sales text creation. In the process of generating sales text, the system dynamically learns combinations of input features and contextual dependencies in high-dimensional space, rather than simply embedding templates, and adopts a non-conventional, algorithmic generation method distinct from rule-based processing or human intuitive judgment, thereby possessing the technical features required by the McRo decision. Technical effects of the system include not only reduction of human costs through automation of sales text generation, but also uniformity of sales text quality, diversification of expressions, personalization for each user, improvement of overall platform sales conversion rate, efficiency in database management, and optimization of communication load. The system is applicable not only to merchandise platforms, but also to various fields requiring text generation, such as real estate introduction texts, job advertisement texts, tourism guide texts, and product descriptions for e-commerce sites.

The system according to the embodiment comprises a receiving unit, a generation unit, and a providing unit. The receiving unit provides an interface for users to input product features. For example, the receiving unit receives information such as product brand name, condition, period of use, and distinctive points. The receiving unit transmits the information input by the user to the generation unit. The generation unit uses generative AI to analyze the information received from the receiving unit and generate sales text to highlight the product's appeal. The generative AI generates attractive expressions and original sentences based on the product features. For example, it may generate sales text such as, “This product is the latest model from a famous brand and is in excellent condition as it has hardly been used. Furthermore, it is equipped with special features that set it apart from other products.” The generation unit transmits the generated sales text to the providing unit. The providing unit provides the sales text transmitted from the generation unit to the user. For example, the providing unit displays the generated sales text to the user and provides an interface for the user to review and make modifications as needed. Thus, the system can automatically generate and provide attractive sales text simply by having users input product features. Specifically, the system receives product feature information input by the user (e.g., brand name, condition, period of use, distinctive points as text data, image data, or audio data) via the receiving unit. The system vectorizes the information received by the receiving unit in the feature extraction section, converting brand name to one-hot encoding, condition to a categorical variable, period of use to a numerical scalar, and distinctive points to a TF-IDF vector or embedding vector, resulting in a multidimensional feature vector (e.g., 128 to 1024 dimensions). If image data is input, the system automatically extracts brand logos and product condition using image recognition models such as CNNs; if audio data is input, it converts it to text using speech recognition models. The system integrates these diverse feature vectors and inputs them to the generative AI section (e.g., a pre-trained large language model or encoder-decoder type Transformer). In the generative AI section, the system uses a model fine-tuned for the sales text generation task, conditioning on the input vectors, and sequentially generates the output token sequence for the sales text (e.g., up to 512 tokens). The system obtains the text sequence of the sales text (e.g., “This product is . . . ”) as output from the generative AI section, and in the sales text optimization section, calculates scores for diversity and originality of expression (e.g., BLEU score, self-attention weight distribution, similarity score), performing threshold judgment and regeneration processing as needed. The final sales text is presented to the user via the output section, and if the user makes modifications, those modifications are accumulated as retraining data. The system executes this series of processes at high speed on a parallel computing cluster using GPUs, achieving significant improvements in processing speed and accuracy compared to conventional manual sales text creation. In the process of generating sales text, the system dynamically learns combinations of input features and contextual dependencies in high-dimensional space, rather than simply embedding templates, and adopts a non-conventional, algorithmic generation method distinct from rule-based processing or human intuitive judgment, thereby possessing the technical features required by the McRo decision. Technical effects of the system include not only reduction of human costs through automation of sales text generation, but also uniformity of sales text quality, diversification of expressions, personalization for each user, improvement of overall platform sales conversion rate, efficiency in database management, and optimization of communication load. The system is applicable not only to merchandise platforms, but also to various fields requiring text generation, such as real estate introduction texts, job advertisement texts, tourism guide texts, and product descriptions for e-commerce sites.

The receiving unit can receive information on product brand name, condition, period of use, and distinctive points. For example, the receiving unit receives information such as product brand name, condition, period of use, and distinctive points. The product brand name can be input as a specific brand name. The product condition can be input as new, used, unused, or other conditions. The period of use can be input as the start date of use or frequency of use. Distinctive points can be input as special features or design characteristics. By receiving detailed information on the product, the receiving unit can generate more attractive sales text. Specifically, the receiving unit is equipped with a user interface module designed to allow users to input product feature information via text input fields, pull-down menus, checkboxes, voice input buttons, and image upload functions. When entering a brand name, the receiving unit automatically displays a list of brand candidates for completion, allowing the user to select from options such as “Brand A” or “Brand B.” When entering product condition, the receiving unit presents categorical options such as “New,” “Unused,” “Used (Good),” “Used (With Damage),” allowing the user to select the applicable condition. When entering period of use, the receiving unit provides calendar widgets or numeric input fields to allow input of specific periods or frequencies, such as “January 2023 to May 2024” or “Used once a week.” When entering distinctive points, the receiving unit provides not only a free description field but also an automatic suggestion function that proposes candidates such as “Waterproof function,” “Limited design,” or “Complete accessories” based on past input history or other users' input. The receiving unit converts these input data into JSON format or multidimensional tensor format (e.g., brand name as one-hot vector, condition as categorical encoding, period of use as scalar value, distinctive points as TF-IDF vector or embedding vector) and transmits them to subsequent feature extraction or generative AI sections. If image data is input, the receiving unit uses an image recognition module (e.g., CNN-based image classification model) to automatically extract brand logos and product condition; if audio data is input, it uses a speech recognition module (e.g., RNN or Transformer-based speech recognition model) to convert it to text, thereby enabling multimodal feature input. As input assistance functions, the receiving unit also provides automatic saving of input content, input error detection, preview display of input content, and reuse of input history. Thus, the receiving unit supports users in performing complex input tasks efficiently and accurately, and by standardizing the quality of input data, contributes to improved accuracy and processing speed of subsequent sales text generation AI. The receiving unit can be deployed not only in merchandise platforms, but also in various systems requiring detailed feature information input, such as real estate property information input, job information input, tourism guide information input, and product registration for e-commerce sites.

The generation unit can generate expressions and original sentences based on product features. The generation unit uses generative AI to generate attractive expressions and original sentences based on product features. The generative AI generates attractive expressions and original sentences based on product features. For example, it may generate sales text such as, “This product is the latest model from a famous brand and is in excellent condition as it has hardly been used. Furthermore, it is equipped with special features that set it apart from other products.” Thus, the generation unit can generate attractive sales text based on product features. Specifically, the generation unit integrates multidimensional feature vectors received from the feature extraction section (e.g., brand name one-hot vector, condition categorical vector, period of use scalar, distinctive points embedding vector, image feature vector, etc.) and inputs them to a pre-trained large language model (e.g., encoder-decoder type Transformer with 1 billion to 100 billion parameters). The generation unit uses a model fine-tuned for the sales text generation task, conditions on the input feature vectors, and sequentially generates the output token sequence for the sales text (e.g., up to 512 tokens). For example, the generation unit receives input vectors such as “Brand name: Brand A, Condition: New, Period of use: Unused, Feature: Limited color” or “Brand name: Brand B, Condition: Used (Good), Period of use: 1 year, Feature: Waterproof function,” and generates output examples such as “This product is a new limited color model from Brand A. It is unused and therefore in excellent condition.” or “This is a model from Brand B with waterproof function, which has been carefully used for one year.” During generation, the generation unit dynamically learns contextual dependencies among input features using self-attention mechanisms, and optimizes combinations of input features and diversity of expressions in high-dimensional space, rather than simply embedding templates. To evaluate diversity and originality of generated sentences, the generation unit calculates BLEU scores, self-attention weight distributions, similarity scores, and performs threshold judgment and regeneration processing as needed. If the quality of the generated sentence falls below a threshold, the generation unit performs regeneration by emphasizing certain input features or generating diverse sentence candidates using different decoder initializations. The generation unit performs batch generation processing on a parallel computing cluster using GPUs, achieving significant improvements in processing speed and accuracy compared to conventional manual sales text creation. In the process of generating sales text, the generation unit adopts a non-conventional, algorithmic generation method distinct from rule-based processing or human intuitive judgment, thereby possessing the technical features required by the McRo decision. Technical effects of the generation unit include uniformity of sales text quality, diversification of expressions, personalization for each user, improvement of sales conversion rate, efficiency in database management, and optimization of communication load. The generation unit is applicable not only to merchandise platforms, but also to various fields requiring text generation, such as real estate introduction texts, job advertisement texts, tourism guide texts, and product descriptions for e-commerce sites.

The providing unit provides the generated sales text to the user and allows the user to make modifications. The providing unit provides the sales text transmitted from the generation unit to the user. For example, the providing unit displays the generated sales text to the user and provides an interface for the user to review and make modifications as needed. The providing unit allows the user to modify parts of the sales text or input additional information. Thus, the providing unit enables the user to review the generated sales text and make modifications as needed. Specifically, the providing unit is equipped with a user interface module that can display the sales text received from the generation unit in real time. The providing unit divides the sales text into sections (e.g., product description, features, condition, recommended points, etc.) and provides inline editing functionality that allows the user to directly edit only the relevant sections. The providing unit includes a revision history management function, enabling version control of user modifications, comparison display with the original generated text, and highlighting of differences before and after modification. The providing unit provides an additional information input field, allowing the user to add new features or supplementary explanations. The providing unit automatically saves modifications in real time, enabling restoration of editing content even if the user accidentally leaves the page. The providing unit transmits modification content to the generative AI section as retraining data, reflecting it in future sales text generation, thereby continuously improving the system's personalization accuracy and diversity of expressions. The providing unit provides a workflow that allows the user to preview the modified sales text immediately and publish or save it after final confirmation. The providing unit analyzes user operation logs and modification trends, and can use this information to optimize future sales text display and editing interfaces. Through these functions, the providing unit provides an environment where users can easily and flexibly customize the generated sales text, thereby improving the quality of sales text and user satisfaction. The providing unit can be deployed not only in merchandise platforms, but also in various systems requiring user text modification and customization, such as real estate introduction texts, job advertisement texts, tourism guide texts, and product descriptions for e-commerce sites.

The receiving unit can estimate the user's emotion and adjust the timing of product feature input based on the estimated emotion. For example, the receiving unit estimates the user's emotion and adjusts the timing of product feature input based on the estimated emotion. For example, if the user is feeling stressed, the receiving unit simplifies the input and requests only the minimum necessary information. If the user is relaxed, the receiving unit prompts for detailed input to maximize the product's appeal. Furthermore, if the user is in a hurry, the receiving unit prioritizes voice input to enable rapid feature input. Thus, by adjusting the timing of input according to the user's emotion, the receiving unit can reduce the user's burden. Emotion estimation is realized using, for example, an emotion engine or generative AI with emotion estimation functionality. Generative AI may be a text generation AI (e.g., LLM) or multimodal generative AI, but is not limited to these examples. Specifically, the receiving unit collects various data obtainable from the input interface in real time during user input operations (e.g., key typing speed, mouse movement, writing style of input text, tone and speed of voice input, facial expression feature vectors from face images, etc.). The receiving unit converts these multimodal input data into formats such as time-series tensors (e.g., 100 frames×20 features), audio spectrograms (e.g., 40dimensions×100 frames per second), and image feature vectors (e.g., 512 dimensions), and inputs them to the emotion estimation AI module. The receiving unit can use a multimodal emotion classification model combining CNN and RNN, or a pre-trained large language model with an emotion classification head as the emotion estimation AI. For example, the receiving unit may be given input such as “Input text: ‘I'm in a hurry today’”, “Voice: fast and high-pitched”, “Face image: frown”, and obtain output such as “Emotion label: stress”, “Emotion score: 0.85”, “Estimated state: in a hurry”. Based on the output of the emotion estimation AI, the receiving unit dynamically changes the number of display items and input procedures on the input interface. For example, if the stress level is high, only the minimum input fields such as “brand name and condition” are presented; if the user is relaxed, additional fields such as “distinctive points and episode input” are displayed. If the user is in a hurry, the “voice input button” is placed at the forefront, minimizing the number of clicks required to complete input. The receiving unit uses threshold judgment (e.g., simplified input mode if stress score is 0.7 or higher) and branching processing (e.g., detailed input mode when relaxed) based on the output of the emotion estimation AI, and also adjusts the granularity and timing of input data sent to subsequent feature extraction and generative AI sections. For training the emotion estimation AI, the receiving unit uses cross-entropy loss functions and multimodal data augmentation techniques to continuously improve emotion estimation accuracy for each user. Unlike conventional simple input interfaces, the receiving unit dynamically estimates the user's psychological state in high-dimensional feature space and optimizes input timing and procedures based on non-conventional rules, thereby possessing the technical features required by the McRo decision. Technical effects of the receiving unit include reduction of user burden, decrease in input abandonment rate, standardization of input data quality, improvement of sales text generation AI accuracy, and overall system processing efficiency. The receiving unit is applicable not only to merchandise platforms, but also to various fields requiring input optimization according to the user's psychological state, such as online application forms, customer support chats, medical interview systems, and educational survey input.

The receiving unit can analyze the user's past input history and propose an appropriate input method. For example, the receiving unit analyzes the user's past input history and proposes an appropriate input method. For example, the receiving unit automatically displays as candidates the product features that the user has frequently input in the past. The receiving unit can also preferentially propose input methods (voice, text, etc.) that the user has used in the past. Furthermore, the receiving unit can predict and propose product features used at specific times based on the user's past input history. Thus, by analyzing the user's past input history, the receiving unit can propose an appropriate input method. Specifically, the receiving unit maintains an input history database for each user, recording metadata for each input session in chronological order, such as “input date and time,” “input content (brand name, condition, features, etc.),” “input method (text, voice, image),” and “input time required.” The receiving unit converts these history data into formats such as time-series arrays (e.g., 30 past entries×10 items), categorical feature vectors (e.g., input method one-hot vector), and frequency count vectors (e.g., occurrence count for each feature word), and inputs them to a history analysis AI module. The receiving unit can use a time-series prediction model based on LSTM or Transformer, or an input pattern recommendation model using collaborative filtering algorithms as the history analysis AI. For example, the receiving unit may be given input such as “input method for past 10 entries: text 8 times, voice 2 times,” “input features for past 30 days: Brand A 5 times, Brand B 3 times,” and obtain output such as “recommended input method: text,” “recommended feature candidates: Brand A, condition: new.” Based on the output of the history analysis AI, the receiving unit dynamically presents on the input interface a “list of frequently used feature candidates” and “recommended input method buttons (e.g., prioritize voice input).” The receiving unit can also automatically predict product features that frequently appear at specific times (e.g., weekday evenings) and suggest them in the input field. The receiving unit uses threshold judgment (e.g., display as candidates features used in 3 or more of the past 5 entries) and branching processing (e.g., default to voice input if voice input usage rate is high) based on the output of the history analysis AI, thereby improving user input efficiency and accuracy. For training the history analysis AI, the receiving unit uses time-series prediction loss functions and user-specific personalization weighting to continuously optimize recommendation accuracy. Unlike conventional static input assistance functions, the receiving unit dynamically learns history patterns for each user in high-dimensional space and optimizes input methods and candidates based on non-conventional rules, thereby possessing the technical features required by the McRo decision. Technical effects of the receiving unit include improved efficiency of input tasks, reduction of input errors, enhancement of user experience, supply of high-quality data to sales text generation AI, and improvement of overall system processing speed. The receiving unit is applicable not only to merchandise platforms, but also to various fields requiring input optimization based on history, such as job information input, medical interviews, product registration for e-commerce sites, and customer support history management.

The receiving unit can customize input items based on the user's current area of interest or purchase history when inputting product features. For example, the receiving unit customizes input items based on the user's current area of interest or purchase history when inputting product features. For example, the receiving unit prioritizes input of features related to products recently purchased by the user. The receiving unit can also prompt input of features related to products based on the user's area of interest. Furthermore, the receiving unit can analyze the user's purchase history and prompt input of highly relevant features. Thus, by customizing input items based on the user's area of interest or purchase history, the receiving unit can prompt input of more appropriate features. Specifically, the receiving unit maintains a purchase history database and area of interest profile for each user, recording information on past purchased products (e.g., product category, brand, price range, purchase date, feature words) and products viewed or searched by the user in chronological order. The receiving unit converts these history data into formats such as categorical vectors (e.g., category one-hot, brand embedding), time-series tensors (e.g., 30 past entries×10 features), and frequency distribution vectors (e.g., frequency of occurrence for each feature word), and inputs them to an interest analysis AI module. The receiving unit can use a user profile estimation model based on Transformer or a product relevance estimation model using graph neural networks as the interest analysis AI. For example, the receiving unit may be given input such as “products purchased in the past 30 days: 5 fashion items, 3 electronics,” “recently viewed categories: outdoor goods,” and obtain output such as “recommended input items: features of outdoor goods, fashion brand names.” Based on the output of the interest analysis AI, the receiving unit dynamically displays on the input interface “input fields for features related to recently purchased products” and “feature candidate lists based on area of interest.” The receiving unit can also automatically suggest feature words that frequently appear in purchase history and use them as input assistance functions. The receiving unit uses threshold judgment (e.g., prioritize display of features with relevance score of 0.8 or higher) and branching processing (e.g., add feature input fields for categories with many purchase history entries) based on the output of the interest analysis AI, providing an optimized input experience for each user. For training the interest analysis AI, the receiving unit uses cross-entropy loss and user-specific personalization weighting to continuously improve recommendation accuracy. Unlike conventional static input item design, the receiving unit dynamically learns the user's interests and purchase history in high-dimensional space and optimizes input items based on non-conventional rules, thereby possessing the technical features required by the McRo decision. Technical effects of the receiving unit include improved efficiency of input tasks, increased relevance of input data, improved accuracy of sales text generation AI, personalization of user experience, and overall system processing efficiency. The receiving unit is applicable not only to merchandise platforms, but also to various fields requiring input optimization based on user profiles, such as job information input, medical interviews, product registration for e-commerce sites, and recommendation systems.

The receiving unit can estimate the user's emotion and determine the priority of products to be input based on the estimated emotion of the user. For example, the receiving unit estimates the user's emotion and determines the priority of products to be input based on the estimated emotion. For example, if the user is excited, the receiving unit prioritizes input of the most attractive features. If the user is relaxed, the receiving unit allows input of detailed features in order. Furthermore, if the user is in a hurry, the receiving unit prioritizes input of only important features. Thus, by determining the priority of products to be input according to the user's emotion, the receiving unit can prompt efficient input of features. Emotion estimation is realized using, for example, an emotion engine or generative AI with emotion estimation functionality. Generative AI may be a text generation AI (e.g., LLM) or multimodal generative AI, but is not limited to these examples. Specifically, the receiving unit collects multimodal data such as input text content, input speed, voice tone, and facial images in real time during user input operations, converts them into formats such as time-series tensors (e.g., 100 frames×20 features), audio spectrograms (e.g., 40 dimensions×100 frames), and image feature vectors (e.g., 512 dimensions), and inputs them to the emotion estimation AI module. The receiving unit can use a multimodal emotion classification model combining CNN and RNN, or a pre-trained large language model with an emotion classification head as the emotion estimation AI. For example, the receiving unit may be given input such as “Input text: ‘I'm really looking forward to this!’”, “Voice: excited tone”, “Face image: smile”, and obtain output such as “Emotion label: excitement”, “Emotion score: 0.92”. Based on the output of the emotion estimation AI, the receiving unit dynamically changes the order of product feature input on the input interface. For example, in an excited state, the “input field for attractive product features” is displayed at the forefront; in a relaxed state, “detailed feature input fields” are displayed sequentially; in a hurry, only important items such as “brand name, condition, price” are prioritized. The receiving unit uses threshold judgment (e.g., prioritize attractive features if excitement score is 0.8 or higher) and branching processing (e.g., simplified input mode in a stressed state) based on the output of the emotion estimation AI, optimizing input efficiency and data quality. For training the emotion estimation AI, the receiving unit uses cross-entropy loss and multimodal data augmentation to continuously improve estimation accuracy. Unlike conventional static input order design, the receiving unit dynamically estimates the user's psychological state in high-dimensional space and optimizes input order based on non-conventional rules, thereby possessing the technical features required by the McRo decision. Technical effects of the receiving unit include improved efficiency of input tasks, reduction of input abandonment rate, improved accuracy of sales text generation AI, personalization of user experience, and overall system processing efficiency. The receiving unit is applicable not only to merchandise platforms, but also to various fields requiring input order optimization according to the user's psychological state, such as online application forms, medical interviews, and educational survey input.

The receiving unit can prioritize input of relevant features based on the user's geographic location information when inputting product features. For example, the receiving unit considers the user's geographic location information when inputting product features and prioritizes input of relevant features. For example, if the user is in a specific region, the receiving unit prioritizes input of features of products popular in that region. If the user is traveling, the receiving unit prompts input of features of products in high demand at the travel destination. Furthermore, the receiving unit can prompt input of region-specific features based on the user's location information. Thus, by considering the user's geographic location information, the receiving unit can prioritize input of relevant features. Specifically, the receiving unit obtains latitude and longitude data from the user's device GPS, IP address, or Wi-Fi location information, and converts it into a geographic feature vector (e.g., latitude, longitude, region category one-hot vector). The receiving unit inputs this location information to a regional product popularity database or trend analysis AI module to extract region-specific popular product categories and feature words. The receiving unit can use a geographic clustering algorithm or a spatiotemporal trend prediction model (e.g., time-series LSTM plus geographic embedding) as the trend analysis AI. For example, the receiving unit may be given input such as “Current location: Shinjuku, Tokyo”, “Travel destination: Sapporo, Hokkaido”, and obtain output such as “Recommended features: winter outerwear, limited design” or “Region-specific features: snow resistance, cold protection function”. Based on the output of the trend analysis AI, the receiving unit dynamically displays on the input interface a “list of popular feature candidates in the region” and “input fields for region-specific features”. If the user is traveling, the receiving unit can automatically suggest feature words in high demand at the travel destination. The receiving unit uses threshold judgment (e.g., prioritize display of features with regional popularity score of 0.7 or higher) and branching processing (e.g., add travel destination-specific features when traveling) based on the output of the trend analysis AI, optimizing the regional suitability of input data. For training the trend analysis AI, the receiving unit uses a loss function combining geographic features and time-series data to continuously improve recommendation accuracy for each region. Unlike conventional static input item design, the receiving unit dynamically analyzes the user's location information in high-dimensional space and optimizes input items based on non-conventional rules, thereby possessing the technical features required by the McRo decision. Technical effects of the receiving unit include improved accuracy of region-specific sales text generation AI, personalization of user experience, improvement of sales conversion rate, and overall system processing efficiency. The receiving unit is applicable not only to merchandise platforms, but also to various fields requiring geographic suitability, such as tourism guide text generation, real estate property information input, and region-limited product e-commerce sites.

The receiving unit can prompt input of relevant features based on the user's social media activity when inputting product features. For example, the receiving unit analyzes the user's social media activity when inputting product features and prompts input of relevant features. For example, the receiving unit prioritizes input of features of products shared by the user on social media. The receiving unit can also analyze the user's social media posts and prompt input of features of related products. Furthermore, the receiving unit can prompt input of features of products that the user's followers are interested in. Thus, by analyzing the user's social media activity, the receiving unit can prompt input of relevant features. Specifically, the receiving unit obtains data such as post history, share history, like history, comment history, and follower reaction history from the user's linked social media accounts via API. The receiving unit collects these data as text data (e.g., post content, comment content), image data (e.g., post images), and time-series data (e.g., post time, reaction time), and performs preprocessing using natural language processing modules and image recognition modules. For text data, the receiving unit performs morphological analysis, TF-IDF vectorization, and embedding vectorization using models such as BERT; for image data, it uses image feature extraction models such as CNNs to automatically extract brand logos and product categories. The receiving unit integrates these feature vectors and inputs them to a social media feature analysis AI module. The receiving unit can use a post content classification model based on Transformer or a user-follower relationship estimation model using graph neural networks as the social media feature analysis AI. For example, the receiving unit may be given input such as “Post content: ‘Bought new sneakers!’”, “Post image: product photo with brand logo”, “Follower reaction: many likes”, and obtain output such as “Recommended features: sneakers, brand name, limited model”, “Follower interest features: color, size”. Based on the output of the social media feature analysis AI, the receiving unit dynamically displays on the input interface “feature candidate list for recently shared products” and “feature candidate list with high follower interest”. The receiving unit can also automatically suggest feature words extracted from post content and use them as input assistance functions. The receiving unit uses threshold judgment (e.g., prioritize display of features with high posting frequency) and branching processing (e.g., add features with high follower interest) based on the output of the social media feature analysis AI, providing an optimized feature input experience for each user. For training the social media feature analysis AI, the receiving unit uses cross-entropy loss and user-specific personalization weighting to continuously improve recommendation accuracy. Unlike conventional static feature input design, the receiving unit dynamically analyzes the user's social media activity in high-dimensional space and optimizes input items based on non-conventional rules, thereby possessing the technical features required by the McRo decision. Technical effects of the receiving unit include improved efficiency of input tasks, increased relevance of input data, improved accuracy of sales text generation AI, personalization of user experience, and overall system processing efficiency. The receiving unit is applicable not only to merchandise platforms, but also to various fields requiring input optimization based on social media activity, such as job information input, medical interviews, product registration for e-commerce sites, and recommendation systems.

The generation unit can estimate the user's emotion and adjust the expression method of the sales text based on the estimated emotion of the user. The generation unit uses generative AI to estimate the user's emotion and adjust the expression method of the sales text based on the estimated emotion. For example, if the user is relaxed, the generation unit generates sales text using soft expressions. If the user is excited, the generation unit generates sales text using emphasized expressions. Furthermore, if the user is in a hurry, the generation unit generates concise sales text that covers the main points. Thus, by adjusting the expression method of the sales text according to the user's emotion, the generation unit can generate more effective sales text. Emotion estimation is realized using, for example, an emotion engine or generative AI with emotion estimation functionality. Generative AI may be a text generation AI (e.g., LLM) or multimodal generative AI, but is not limited to these examples. Specifically, the generation unit inputs multimodal emotion data obtained from the receiving unit or user operation logs (e.g., writing style of input text, input speed, voice tone, facial images, etc.) to the emotion estimation AI module. The generation unit can use a multimodal emotion classification model combining CNN and RNN, or a pre-trained large language model with an emotion classification head as the emotion estimation AI. For example, the generation unit may be given input such as “Input text: ‘I'm taking it easy today’”, “Voice: calm tone”, “Face image: smile”, and obtain output such as “Emotion label: relaxed”, “Emotion score: 0.88”. Based on the output of the emotion estimation AI, the generation unit provides style control tokens or parameters (e.g., formal, casual, emphatic, concise, etc.) as conditions to the sales text generation AI (e.g., encoder-decoder type Transformer). For a relaxed state, the generation unit adds a “soft expression token”; for an excited state, an “emphasized expression token”; for a hurried state, a “concise expression token,” controlling the sales text generation AI to sequentially generate the output token sequence (e.g., up to 512 tokens) in the corresponding style. Example outputs include “Relaxed: ‘This product gently fits into your daily life.’”, “Excited: ‘This is a limited model available only now—don't miss it!’”, “Hurried: ‘New, immediate delivery, special price.’” The generation unit evaluates whether the style of the generated text matches the emotion estimation result using BLEU scores or style classifiers, and performs threshold judgment and regeneration processing as needed. The generation unit executes these processes at high speed on a parallel computing cluster using GPUs, achieving significant improvements in processing speed and personalization accuracy compared to conventional manual expression adjustment. In the process of generating sales text, the generation unit dynamically learns style control according to emotional state in high-dimensional space, rather than simply embedding templates, and adopts a non-conventional, algorithmic generation method, thereby possessing the technical features required by the McRo decision. Technical effects of the generation unit include personalization of sales text, improvement of user satisfaction, improvement of sales conversion rate, expansion of expression diversity, and overall system processing efficiency. The generation unit is applicable not only to merchandise platforms, but also to various fields requiring text generation according to emotion, such as job advertisement texts, tourism guide texts, and product descriptions for e-commerce sites.

The generation unit can adjust the level of detail of the sales text based on the importance of the product when generating the sales text. The generation unit uses generative AI to adjust the level of detail of the sales text based on the importance of the product when generating the sales text. For example, for expensive products, the generation unit generates sales text including detailed explanations. For general products, the generation unit generates sales text including standard explanations. Furthermore, for inexpensive products, the generation unit generates sales text including concise explanations. Thus, by adjusting the level of detail of the sales text based on the importance of the product, the generation unit can generate appropriate sales text. Specifically, the generation unit inputs numerical and categorical data such as product price, rarity, brand value, exclusivity, and demand prediction score received from the receiving unit as importance feature vectors (e.g., price scalar, brand one-hot, exclusivity flag) to the generative AI section. The generation unit uses an importance determination AI module (e.g., LightGBM or MLP-based importance classification model) to output labels such as “high importance,” “medium importance,” or “low importance,” and provides these as condition tokens to the sales text generation AI (e.g., encoder-decoder type Transformer). For example, the generation unit may be given input such as “Price: 100,000 yen, Brand: luxury brand, Exclusivity: limited to 100 units” or “Price: 3,000 yen, Brand: general, Exclusivity: none,” and generate output such as “High importance: ‘This product is a luxury brand model limited to 100 units, crafted with attention to detail.’” or “Low importance: ‘An affordable product ideal for everyday use.’” The generation unit evaluates whether the level of detail of the generated text matches the importance label using text length (number of tokens), information content score, and detail level classifiers, and performs threshold judgment and regeneration processing as needed. For training the importance determination AI, the generation unit uses cross-entropy loss and data augmentation for each importance level to continuously improve determination accuracy. Unlike conventional static template generation, the generation unit dynamically determines product importance in high-dimensional space and optimizes the level of detail based on non-conventional rules, thereby possessing the technical features required by the McRo decision. Technical effects of the generation unit include uniformity of sales text quality, personalization of user experience, improvement of sales conversion rate, and overall system processing efficiency. The generation unit is applicable not only to merchandise platforms, but also to various fields requiring text generation according to importance, such as real estate introduction texts, job advertisement texts, and product descriptions for e-commerce sites.

The generation unit can apply different generation algorithms according to the type of product when generating the sales text. The generation unit uses generative AI to apply different generation algorithms according to the type of product when generating the sales text. For example, for electronic devices, the generation unit applies an algorithm that emphasizes technical details. For fashion items, the generation unit applies an algorithm that emphasizes design and style. Furthermore, for furniture, the generation unit applies an algorithm that emphasizes functionality and materials. Thus, by applying different generation algorithms according to the type of product, the generation unit can generate more appropriate sales text. Specifically, the generation unit inputs product category information (e.g., electronics, fashion, furniture, food, etc.) received from the receiving unit as categorical vectors (one-hot or embedding vectors) to the generative AI section. The generation unit prepares different generation algorithms for each category (e.g., technical specification-emphasizing Transformer for electronics, design/style-emphasizing Transformer for fashion, functionality/material-emphasizing Transformer for furniture), and automatically selects the optimal model or decoder head according to the input category. For example, the generation unit may be given input such as “Category: electronics, Feature: 4K support, long battery life,” “Category: fashion, Feature: limited color, trendy design,” “Category: furniture, Feature: solid wood, storage capacity,” and generate output such as “Electronics: ‘A latest model combining 4K high resolution and long battery life.’”, “Fashion: ‘A standout piece with limited color and trendy design.’”, “Furniture: ‘Luxuriously crafted from solid wood with excellent storage capacity.’” The generation unit controls selection of generation algorithms for each category using category classifiers or rule-based branching, and evaluates whether the content of the generated text matches category characteristics using BLEU scores or content classifiers, performing threshold judgment and regeneration processing as needed. For training category-specific models, the generation unit uses fine-tuning with category-specific corpora and data augmentation to continuously improve generation accuracy. Unlike conventional general-purpose generation with a single model, the generation unit dynamically selects and applies optimized algorithms for each product type in high-dimensional space, thereby possessing the technical features required by the McRo decision. Technical effects of the generation unit include optimization of sales text content, personalization of user experience, improvement of sales conversion rate, and overall system processing efficiency. The generation unit is applicable not only to merchandise platforms, but also to various fields requiring category-specific text generation, such as real estate introduction texts, job advertisement texts, and product descriptions for e-commerce sites.

The generation unit can adjust the length of the sales text based on the estimated emotion of the user. The generation unit uses generative AI to estimate the user's emotion and adjust the length of the sales text based on the estimated emotion. For example, if the user is relaxed, the generation unit generates a longer sales text including detailed explanations. If the user is in a hurry, the generation unit generates a concise and short sales text. Furthermore, if the user is excited, the generation unit generates a medium-length sales text including emphasized expressions. Thus, by adjusting the length of the sales text according to the user's emotion, the generation unit can generate more effective sales text. Emotion estimation is realized using, for example, an emotion engine or generative AI with emotion estimation functionality. Generative AI may be a text generation AI (e.g., LLM) or multimodal generative AI, but is not limited to these examples. Specifically, the generation unit inputs multimodal emotion data obtained from the receiving unit or user operation logs (e.g., writing style of input text, input speed, voice tone, facial images, etc.) to the emotion estimation AI module. The generation unit can use a multimodal emotion classification model combining CNN and RNN, or a pre-trained large language model with an emotion classification head as the emotion estimation AI. For example, the generation unit may be given input such as “Input text: ‘I'm taking it easy today’”, “Voice: calm tone”, “Face image: smile”, and obtain output such as “Emotion label: relaxed”, “Emotion score: 0.88”. Based on the output of the emotion estimation AI, the generation unit provides length control tokens or parameters (e.g., short, medium, long) as conditions to the sales text generation AI (e.g., encoder-decoder type Transformer). For a relaxed state, the generation unit adds a “long” length control token; for a hurried state, “short”; for an excited state, “medium,” controlling the sales text generation AI to sequentially generate the output token sequence (e.g., short=50 tokens, medium=150 tokens, long=300 tokens) in the corresponding length. Example outputs include “Long: ‘This product is . . . (detailed explanation continues)’”, “Short: ‘New, immediate delivery, special price.’”, “Medium: ‘This is a limited model available only now—don't miss it!’” The generation unit evaluates whether the length of the generated text matches the emotion estimation result using number of tokens or length classifiers, and performs threshold judgment and regeneration processing as needed. The generation unit executes these processes at high speed on a parallel computing cluster using GPUs, achieving significant improvements in processing speed and personalization accuracy compared to conventional manual length adjustment. In the process of generating sales text, the generation unit dynamically learns length control according to emotional state in high-dimensional space, rather than simply embedding templates, and adopts a non-conventional, algorithmic generation method, thereby possessing the technical features required by the McRo decision. Technical effects of the generation unit include personalization of sales text, improvement of user satisfaction, improvement of sales conversion rate, expansion of expression diversity, and overall system processing efficiency. The generation unit is applicable not only to merchandise platforms, but also to various fields requiring text length control according to emotion or situation, such as job advertisement texts, tourism guide texts, and product descriptions for e-commerce sites.

The generation unit can determine the priority of the sales text according to the submission timing of the product when generating the sales text. The generation unit uses generative AI to determine the priority of the sales text according to the submission timing of the product when generating the sales text. For example, for new products, the generation unit places the sales text in the most prominent position. For seasonal products, the generation unit generates sales text tailored to the season. Furthermore, for products on sale, the generation unit generates sales text emphasizing discount information. Thus, by determining the priority of the sales text according to the submission timing of the product, the generation unit can provide sales text at the appropriate timing. Specifically, the generation unit inputs time-series data and flag information such as product submission date, sales start date, season information, and sale period received from the receiving unit as submission timing feature vectors (e.g., submission date timestamp, season one-hot, sale flag) to the generative AI section. The generation unit uses a submission timing determination AI module (e.g., time-series LSTM or rule-based classifier) to output labels such as “new product,” “seasonal product,” or “sale product,” and provides these as condition tokens to the sales text generation AI (e.g., encoder-decoder type Transformer). For example, the generation unit may be given input such as “Submission date: 2024-06-01, Season: summer, Sale: yes” or “Submission date: 2024-01-10, Season: winter, Sale: no,” and generate output such as “New product: ‘This is the latest model newly released this season.’”, “Seasonal product: ‘A perfect item for summer.’”, “Sale product: ‘Available now at a special discount price.’” The generation unit evaluates whether the content of the generated text matches the submission timing label using content classifiers or BLEU scores, and performs threshold judgment and regeneration processing as needed. For training the submission timing determination AI, the generation unit uses time-series data augmentation and cross-entropy loss to continuously improve determination accuracy. Unlike conventional static sales text display, the generation unit dynamically determines product submission timing in high-dimensional space and optimizes priority and content based on non-conventional rules, thereby possessing the technical features required by the McRo decision. Technical effects of the generation unit include optimization of sales text timing, personalization of user experience, improvement of sales conversion rate, and overall system processing efficiency. The generation unit is applicable not only to merchandise platforms, but also to various fields requiring text generation according to timing, such as seasonal product e-commerce sites, event guide texts, and sale information distribution.

The generation unit can adjust the order of the sales text according to the relevance of the product when generating the sales text. The generation unit uses generative AI to adjust the order of the sales text according to the relevance of the product when generating the sales text. For example, the generation unit prioritizes display of sales text for highly relevant products. The generation unit can also postpone display of sales text for less relevant products. Furthermore, the generation unit can dynamically adjust the order of sales text based on the user's interest. Thus, by adjusting the order of the sales text according to the relevance of the product, the generation unit can provide more effective sales text. Specifically, the generation unit inputs product feature vectors, user browsing and purchase history vectors, and related product network information obtained from the receiving unit or user profile to a relevance estimation AI module (e.g., graph neural network or collaborative filtering model). The generation unit obtains output from the relevance estimation AI such as relevance scores for each product (e.g., continuous values from 0.0 to 1.0) and related product pair lists. For example, the generation unit may be given input such as “Product A: Brand X, Category Y”, “Product B: Brand X, Category Z”, “User interest: Brand X”, and obtain output such as “Product A-Product B relevance: 0.85”, “Product A-Product C relevance: 0.40”. Based on the relevance scores, the generation unit automatically determines the display order of the sales text, placing highly relevant products at the top and less relevant products at the bottom. The generation unit also adjusts the order in a personalized manner by considering the user's interest score. For training the relevance estimation AI, the generation unit applies ranking loss functions using user behavior logs and purchase history data to continuously improve recommendation accuracy. Unlike conventional static product list display, the generation unit dynamically estimates product relevance in high-dimensional space and optimizes order based on non-conventional rules, thereby possessing the technical features required by the McRo decision. Technical effects of the generation unit include optimization of sales text display, personalization of user experience, improvement of sales conversion rate, and overall system processing efficiency. The generation unit is applicable not only to merchandise platforms, but also to various fields requiring order optimization based on relevance, such as recommendation systems, job advertisement display, and product list display for e-commerce sites.

The providing unit can estimate the user's emotion and adjust the display method of the sales text based on the estimated emotion of the user. For example, the providing unit estimates the user's emotion and adjusts the display method of the sales text based on the estimated emotion. For example, if the user is relaxed, the providing unit provides a display method including detailed information. If the user is in a hurry, the providing unit provides a display method focusing on key points. Furthermore, if the user is excited, the providing unit provides a visually stimulating display method. Thus, by adjusting the display method of the sales text according to the user's emotion, the providing unit enables more effective display. Emotion estimation is realized using, for example, an emotion engine or generative AI with emotion estimation functionality. Generative AI may be a text generation AI (e.g., LLM) or multimodal generative AI, but is not limited to these examples. Specifically, the providing unit collects multimodal data in real time from user input operations and browsing behavior (e.g., writing style of input text, input speed, voice tone, facial expression features from face images, mouse movement, click frequency, scroll speed, etc.). The providing unit converts these data into formats such as time-series tensors (e.g., 100 frames×20 features), audio spectrograms (e.g., 40 dimensions×100 frames), and image feature vectors (e.g., 512 dimensions), and inputs them to the emotion estimation AI module. The providing unit can use a multimodal emotion classification model combining CNN and RNN, or a pre-trained large language model with an emotion classification head as the emotion estimation AI. For example, the providing unit may be given input such as “Input text: ‘I'm taking it easy today’”, “Voice: calm tone”, “Face image: smile”, and obtain output such as “Emotion label: relaxed”, “Emotion score: 0.88”. Based on the output of the emotion estimation AI, the providing unit dynamically controls parameters such as layout, amount of information, highlight color, animation effects, font size, and display order of the sales text display interface. For example, in a relaxed state, the providing unit expands the detailed information section, adds supplementary explanations and Q&A fields, and applies calm color schemes and larger fonts; in a hurried state, the providing unit displays only key points in bullet form, highlights important items, and applies a simple UI minimizing the number of clicks; in an excited state, the providing unit applies colorful highlight colors, animated banners, and impactful fonts or icons. The providing unit uses threshold judgment (e.g., detailed display mode if relaxation score is 0.8 or higher) and branching processing (e.g., simplified display mode if in a hurry) based on the output of the emotion estimation AI, providing an optimized display experience for each user. For training the emotion estimation AI, the providing unit uses cross-entropy loss and multimodal data augmentation to continuously improve estimation accuracy. Unlike conventional static display design, the providing unit dynamically estimates the user's psychological state in high-dimensional space and optimizes display methods based on non-conventional rules, thereby possessing the technical features required by the McRo decision. Technical effects of the providing unit include personalization of user experience, improvement of sales text viewing rate and conversion rate, reduction of abandonment rate, and overall system processing efficiency. The providing unit is applicable not only to merchandise platforms, but also to various fields requiring display optimization according to emotion or situation, such as job advertisement display, tourism guide text display, and product description display for e-commerce sites.

The providing unit can select an optimal display method by referring to the user's past modification history when providing the sales text. For example, the providing unit selects an optimal display method by referring to the user's past modification history when providing the sales text. For example, the providing unit provides an optimal display method based on the style of sales text previously modified by the user. The providing unit can also infer the preferred format from the user's modification history and adjust the display method. Furthermore, the providing unit can analyze the user's modification history and propose the most effective display method. Thus, by referring to the user's past modification history, the providing unit can select an optimal display method. Specifically, the providing unit maintains a modification history database for each user, recording the modification content of each sales text (e.g., modified sections, writing style before and after modification, added/deleted content, modification time, number of modifications, time required for modification, etc.) in chronological order. The providing unit converts these history data into formats such as time-series arrays (e.g., 30 past entries×10 items), categorical feature vectors (e.g., modification style one-hot vector), and frequency count vectors (e.g., occurrence count for each modification pattern), and inputs them to a modification history analysis AI module. The providing unit can use a time-series prediction model based on LSTM or Transformer, or a modification pattern classification model using clustering algorithms as the modification history analysis AI. For example, the providing unit may be given input such as “Modification style for past 10 entries: casual 6 times, formal 4 times,” “Modified sections for past 30 days: title 5 times, feature description 10 times,” and obtain output such as “Recommended display style: casual,” “Recommended display format: title emphasis type.” Based on the output of the modification history analysis AI, the providing unit dynamically presents on the sales text display interface “frequently used display styles” and “recommended format buttons (e.g., bullet point display, detailed display).” If a specific modification trend (e.g., always modifying the title) is detected, the providing unit can automatically apply a UI that emphasizes the relevant section or makes it easier to edit. The providing unit uses threshold judgment (e.g., default display of style used in 3 or more of the past 5 entries) and branching processing (e.g., default to detailed display if detailed display usage rate is high) based on the output of the modification history analysis AI, thereby improving user display experience and editing efficiency. For training the modification history analysis AI, the providing unit uses time-series prediction loss functions and user-specific personalization weighting to continuously optimize recommendation accuracy. Unlike conventional static display assistance functions, the providing unit dynamically learns modification patterns for each user in high-dimensional space and optimizes display methods and candidates based on non-conventional rules, thereby possessing the technical features required by the McRo decision. Technical effects of the providing unit include improved efficiency of display tasks, personalization of user experience, supply of high-quality data to sales text generation AI, and improvement of overall system processing speed. The providing unit is applicable not only to merchandise platforms, but also to various fields requiring display optimization based on history, such as job advertisement display, medical interview result display, product description display for e-commerce sites, and customer support history management.

The providing unit can add a function to reflect user feedback in real time when providing the sales text. For example, the providing unit adds a function to reflect user feedback in real time when providing the sales text. For instance, when the user provides feedback on the sales text, the providing unit immediately reflects modifications in real time. Additionally, the providing unit can dynamically adjust the display method of the sales text based on user feedback. Furthermore, the providing unit can collect user feedback and reflect it in the next sales text generation. As a result, the providing unit can provide more appropriate sales text by reflecting user feedback in real time. Specifically, the providing unit collects feedback entered by the user on the sales text display screen (e.g., text comments, five-level ratings, modification suggestions, number of clicks, dwell time, reaction buttons, etc.) in real time. The providing unit converts these feedback data into formats such as categorical vectors (e.g., rating one-hot), numerical vectors (e.g., rating score, dwell seconds), and text vectors (e.g., comment embeddings), and inputs them into a feedback analysis AI module. The providing unit can utilize Transformer-based text classification models, regression models, and clustering algorithms as the feedback analysis AI. As input examples, the providing unit may receive “Comment: ‘Please make it more concise’”, “Rating: 3”, “Dwell time: 5 seconds”, and as output examples, obtain “Recommended modification: summary display”, “Recommended display method: simple mode”, etc. Based on the output results of the feedback analysis AI, the providing unit dynamically changes the layout, amount of information, emphasis points, and display order of the sales text display interface in real time. When the user enters a modification suggestion, the corresponding part can be immediately edited, reflected, and previewed. The providing unit accumulates the collected feedback in a history database and utilizes it as training data for the next sales text generation AI or display optimization AI. For training the feedback analysis AI, the providing unit uses cross-entropy loss and personalized weighting for each user to continuously improve reflection accuracy. Unlike conventional static display designs, the providing unit dynamically analyzes user feedback in high-dimensional space and optimizes display methods and content based on non-conventional rules, thereby possessing the technical features required by the McRo precedent. Technical effects of the providing unit include personalization of user experience, improvement of sales text quality, increase in conversion rate, and overall system processing efficiency. The providing unit is applicable not only to merchandise platforms but also to various fields requiring real-time feedback reflection, such as job advertisement display, tourist information display, and product description display on e-commerce sites.

The providing unit can estimate the user's emotion and adjust the modification procedure of the sales text based on the estimated emotion. For example, the providing unit estimates the user's emotion and adjusts the modification procedure of the sales text according to the estimated emotion. For instance, if the user is relaxed, the providing unit provides detailed modification procedures. If the user is in a hurry, the providing unit can provide concise modification procedures. Furthermore, if the user is excited, the providing unit can provide visually stimulating modification procedures. By adjusting the modification procedure according to the user's emotion, the providing unit enables more appropriate modifications. Emotion estimation is realized, for example, by using an emotion engine or generative AI with emotion estimation functions, such as text generation AI (e.g., LLM) or multimodal generative AI, but is not limited to these examples. Specifically, the providing unit collects multimodal data obtained from the user's input operations and browsing behavior in real time (e.g., input text style, input speed, voice tone, facial expression features from face images, mouse movements, click frequency, scroll speed, etc.). The providing unit converts these data into formats such as time-series tensors (e.g., 100 frames×20 features), voice spectrograms (e.g., 40 dimensions×100 frames), and image feature vectors (e.g., 512 dimensions), and inputs them into an emotion estimation AI module. The providing unit can use multimodal emotion classification models combining CNN and RNN, or pre-trained large language models with emotion classification heads as the emotion estimation AI. As input examples, the providing unit may receive “Input text: ‘I'm taking it easy today’”, “Voice: calm tone”, “Face image: smile”, and as output examples, obtain “Emotion label: relaxed”, “Emotion score: 0.88”, etc. Based on the output results of the emotion estimation AI, the providing unit dynamically controls the procedures and guide displays of the sales text modification interface, the method of presenting modification candidates, the complexity of the editing UI, and the presence or absence of help displays. For example, in a relaxed state, the providing unit provides “detailed modification procedure guides”, “hint displays”, and “visualization of modification history”; in a hurried state, “one-click modification”, “minimal input fields”, and “editing of only important items”; and in an excited state, “animated guides”, “colorful display of modification candidates”, and “interactive UI”. The providing unit uses the output of the emotion estimation AI for threshold judgment (e.g., detailed procedure mode for relaxation score of 0.8 or higher) and branching processing (e.g., simple procedure mode for hurried state), providing an optimized modification experience for each user. For training the emotion estimation AI, the providing unit uses cross-entropy loss and multimodal data augmentation to continuously improve estimation accuracy. Unlike conventional static modification procedure designs, the providing unit dynamically estimates the user's psychological state in high-dimensional space and optimizes modification procedures based on non-conventional rules, thereby possessing the technical features required by the McRo precedent. Technical effects of the providing unit include personalization of user experience, efficiency of modification work, uniformity of sales text quality, and overall system processing efficiency. The providing unit is applicable not only to merchandise platforms but also to various fields requiring optimization of modification procedures according to emotion and situation, such as job advertisement modification, tourist information modification, and product description modification on e-commerce sites.

The providing unit can select an optimal display method by considering the user's device information when providing the sales text. For example, the providing unit selects an optimal display method by considering the user's device information when providing the sales text. For instance, if the user is using a smartphone, the providing unit provides a display method adapted to the screen size. If the user is using a tablet, the providing unit can provide a display method optimized for a larger screen. Furthermore, if the user is using a desktop, the providing unit can provide a display method including detailed information. By considering the user's device information, the providing unit can provide the optimal display method. Specifically, the providing unit collects device information obtained from the user's terminal in real time (e.g., device type, screen resolution, OS type, browser type, touch capability, connection speed, etc.). The providing unit converts these device information into formats such as categorical vectors (e.g., device type one-hot), numerical vectors (e.g., screen size, resolution), and binary flags (e.g., touch capability), and inputs them into a device optimization AI module. The providing unit can utilize decision tree models, LightGBM, and rule-based classifiers as the device optimization AI. As input examples, the providing unit may receive “Device: smartphone, screen width: 375 px”, “Device: tablet, screen width: 1024 px”, “Device: desktop, screen width: 1920 px”, and as output examples, obtain “Recommended display layout: vertical scroll type”, “Recommended font size: large”, “Recommended information amount: detailed”, etc. Based on the output results of the device optimization AI, the providing unit dynamically controls the layout, font size, image display method, information amount, button arrangement, and operability of the sales text display interface. For example, for smartphones, the providing unit applies “vertical scroll layout”, “touch operation optimization”, “carousel display of images”, and “display of only key points”; for tablets, “two-column display”, “large images”, and “addition of detailed information section”; and for desktops, “three-column display”, “detailed supplementary information”, and “simultaneous display of multiple products”. The providing unit uses the output of the device optimization AI for threshold judgment (e.g., mobile display for screen width less than 400 px) and branching processing (e.g., change button size based on touch capability), providing an optimized display experience for each user. For training the device optimization AI, the providing unit uses cross-entropy loss and device-specific data augmentation to continuously improve optimization accuracy. Unlike conventional static responsive designs, the providing unit dynamically analyzes device information in high-dimensional space and optimizes display methods based on non-conventional rules, thereby possessing the technical features required by the McRo precedent. Technical effects of the providing unit include personalization of user experience, optimization of display speed, improvement of sales text viewing rate and conversion rate, and overall system processing efficiency. The providing unit is applicable not only to merchandise platforms but also to various fields requiring device optimization, such as job advertisement display, tourist information display, and product description display on e-commerce sites.

The providing unit can analyze the user's social media activity and provide relevant feedback when providing the sales text. For example, the providing unit analyzes the user's social media activity and provides relevant feedback when providing the sales text. For instance, based on feedback on sales texts shared by the user on social media, the providing unit provides the optimal display method. Additionally, the providing unit can analyze the user's social media posts and provide relevant feedback. Furthermore, the providing unit can reflect features of sales texts that the user's followers are interested in. By analyzing the user's social media activity, the providing unit can provide relevant feedback. Specifically, the providing unit obtains data such as post history, share history, like history, comment history, and follower reaction history from the user's linked social media accounts via API. The providing unit collects these data as text data (e.g., post content, comment content), image data (e.g., post images), and time-series data (e.g., post time, reaction time), and performs preprocessing using natural language processing modules and image recognition modules. For text data, the providing unit performs morphological analysis, TF-IDF vectorization, and embedding vectorization using models such as BERT; for image data, the providing unit uses image feature extraction models such as CNN to automatically extract brand logos and product categories. The providing unit integrates these feature vectors and inputs them into a social media feature analysis AI module. The providing unit can utilize Transformer-based post content classification models and graph neural network-based user-follower relationship estimation models as the social media feature analysis AI. As input examples, the providing unit may receive “Post content: ‘Bought new sneakers!’”, “Post image: product photo with brand logo”, “Follower reaction: many likes”, and as output examples, obtain “Recommended display: emphasize sales text related to sneakers”, “Follower interest features: color, size”, etc. Based on the output results of the social media feature analysis AI, the providing unit dynamically displays on the sales text display interface “Effect of recently shared sales texts”, “Emphasized display of features with high follower interest”, and “Feedback summary based on post content”. The providing unit can also automatically suggest feature words extracted from post content and follower reaction trends as display support functions. The providing unit uses the output of the social media feature analysis AI for threshold judgment (e.g., prioritize display of features with high posting frequency) and branching processing (e.g., additionally display features with high follower interest), providing an optimized feedback display experience for each user. For training the social media feature analysis AI, the providing unit uses cross-entropy loss and personalized weighting for each user to continuously improve recommendation accuracy. Unlike conventional static feedback display designs, the providing unit dynamically analyzes social media activity in high-dimensional space and optimizes display content based on non-conventional rules, thereby possessing the technical features required by the McRo precedent. Technical effects of the providing unit include efficiency of display operations, improvement of feedback relevance, enhancement of sales text generation AI accuracy, personalization of user experience, and overall system processing efficiency. The providing unit is applicable not only to merchandise platforms but also to various fields requiring feedback optimization based on social media activity, such as job advertisement display, medical interview result display, product description display on e-commerce sites, and recommendation systems.

The system according to the embodiment is not limited to the examples described above and can be variously modified as follows. Specifically, the system can flexibly change the configuration of each module and data flow, such as the receiving unit, feature extraction unit, generation AI unit, sales text optimization unit, and providing unit, according to user attributes and platform requirements. The system can adopt not only Encoder-Decoder type Transformers as the AI model architecture, but also RNNs, CNNs, graph neural networks, mixture of experts models, autoregressive language models, and others. In the feature extraction unit, the system can utilize advanced models such as Vision Transformer or EfficientNet for image feature extraction, and Conformer or Wav2Vec2.0 for speech recognition. In the sales text generation AI unit, the system can employ ensemble methods combining multiple generation models or multitask learning methods with different decoder heads for each product category. In the sales text optimization unit, the system can evaluate the quality of generated texts using various metrics such as BLEU score, self-attention weight distribution, BERTScore, ROUGE, content diversity index, and user evaluation scores. In the providing unit, the system can integrate diverse input information such as user emotion estimation, history analysis, device information, and social media activity to dynamically optimize display methods, modification procedures, and feedback reflection methods. The system can support not only parallel computation clusters using GPUs, but also fast inference on TPUs, FPGAs, and distributed cloud environments. As application fields for sales text generation, the system can be deployed in various domains requiring text generation, such as merchandise platforms, real estate introduction texts, job advertisement texts, tourist information texts, product description texts for e-commerce sites, medical interview results, educational material descriptions, and event information texts. Through such flexible configuration changes and diversification of AI models, the system exhibits technical effects such as overwhelming diversity of expression, personalization accuracy, processing speed, and operational efficiency compared to conventional static template generation and manual text creation.

The receiving unit can utilize voice input and image recognition when the user inputs product features. For example, when the user uploads a product photo, the receiving unit can automatically extract the product's brand name and condition using image recognition technology. Additionally, when the user describes product features by voice, the receiving unit can convert the speech to text using speech recognition technology to assist input. This enables the user to input product features more easily and reduces the effort required for input. Specifically, the receiving unit provides image upload functionality and a voice input button on the user interface, allowing the user to easily input product images and voice descriptions. When image data is received, the receiving unit automatically performs brand logo detection, product category classification, condition determination (e.g., new, used, damaged, etc.), and color/shape feature extraction using image recognition models such as CNN or Vision Transformer. As image input examples, the receiving unit may receive “Product image: sneakers with brand logo”, “Product image: bag with damage”, and as output examples, obtain “Brand name: sneaker brand”, “Condition: used (damaged)”, etc. When voice data is received, the receiving unit uses speech recognition models based on RNN or Transformer (e.g., Wav2Vec2.0, Conformer, etc.) to convert the speech waveform into a spectrogram and transcribe it into text at the phoneme or word level. As voice input examples, the receiving unit may receive “Voice: ‘I bought this bag two years ago and used it once a week’”, and as output examples, obtain “Text: ‘Purchased two years ago, used once a week’”, etc. The receiving unit sends the output of the image recognition and speech recognition AI to the feature extraction unit, performs one-hot encoding and embedding vectorization, and integrates the data for input to the subsequent generation AI unit. The receiving unit can dynamically control the display of input assistance UI and re-input guidance according to the presence and quality of image and voice input. For training the image recognition and speech recognition AI, the receiving unit uses cross-entropy loss and data augmentation methods to continuously improve recognition accuracy. Unlike conventional designs that accept only text input, the receiving unit dynamically realizes multimodal feature extraction in high-dimensional space and optimizes input assistance based on non-conventional rules, thereby possessing the technical features required by the McRo precedent. Technical effects of the receiving unit include efficiency of input operations, reduction of input errors, improvement of user experience, supply of high-quality data to the sales text generation AI, and improvement of overall system processing speed. The receiving unit is applicable not only to merchandise platforms but also to various fields requiring image and voice input, such as job information input, medical interviews, product registration on e-commerce sites, and customer support history management.

The generation unit can generate a sales text tailored to the target customer segment based on the product features. For example, for products aimed at younger customers, the generation unit generates sales text using casual and friendly expressions. For products aimed at elderly customers, the generation unit can generate sales text using polite and easy-to-understand expressions. Furthermore, for products aimed at business persons, the generation unit can generate sales text using professional and highly reliable expressions. By generating sales text tailored to the target customer segment, the generation unit can achieve more effective sales promotion. Specifically, the generation unit inputs product feature vectors received from the receiving unit, along with target customer segment information (e.g., age group, gender, occupation, purchase history, area of interest, etc.) as categorical or embedding vectors into the generation AI unit. The generation unit assigns style control tokens (e.g., casual, polite, professional, etc.) or parameters for each target segment as conditions to the sales text generation AI (such as Encoder-Decoder type Transformer), and sequentially generates output token sequences (e.g., up to 512 tokens). As input examples, the generation unit may receive “Target: young customers, Feature: limited color”, “Target: elderly customers, Feature: large dial”, “Target: business persons, Feature: high-performance CPU”, and as output examples, generate “For young customers: ‘A trendy item with an attractive limited color!’”, “For elderly customers: ‘Easy to see with a large dial and simple to operate’”, “For business persons: ‘Equipped with a high-performance CPU to maximize work efficiency’”, etc. The generation unit evaluates whether the style of the generated text matches the target segment using BLEU scores or style classifiers, and can perform threshold judgment or regeneration processing. For model training for each target segment, the generation unit uses fine-tuning with segment-specific corpora and data augmentation to continuously improve generation accuracy. Unlike conventional single-style generation, the generation unit dynamically selects and applies optimized expressions for each target customer segment in high-dimensional space, thereby possessing the technical features required by the McRo precedent. Technical effects of the generation unit include optimization of sales text content, personalization of user experience, improvement of sales conversion rate, and overall system processing efficiency. The generation unit is applicable not only to merchandise platforms but also to various fields requiring text generation tailored to the target segment, such as job advertisement texts, tourist information texts, and product description texts for e-commerce sites.

When providing the generated sales text to the user, the providing unit can give real-time feedback on the effectiveness of the sales text. For example, the providing unit notifies the user of the number of views and clicks the sales text has received. Additionally, the providing unit can report to the user how many purchases have resulted from the sales text. Furthermore, the providing unit can analyze the effectiveness of the sales text and propose improvements. As a result, the providing unit enables the user to understand the effectiveness of the sales text and provides reference information for creating more effective sales texts. Specifically, the providing unit collects effectiveness indicator data for each sales text in real time, such as number of views, clicks, purchases, dwell time, bounce rate, and shares, and manages them as time-series arrays (e.g., daily×7 indicators), numerical vectors (e.g., latest value for each indicator), and history databases. The providing unit inputs these effectiveness data into an effectiveness analysis AI module (e.g., regression model, time-series prediction model, clustering model, etc.) and outputs effectiveness scores and improvement suggestions for each sales text. As input examples, the providing unit may receive “Views: 1000,Clicks: 120, Purchases: 10”, “Dwell time: average 30 seconds, Bounce rate: 20%”, and as output examples, obtain “Effectiveness score: 0.85”, “Improvement suggestion: emphasize the title, place key points at the beginning”, etc. Based on the output results of the effectiveness analysis AI, the providing unit dynamically displays “real-time effectiveness graphs”, “suggested improvements”, and “comparisons with past sales texts” on the sales text display interface. For training the effectiveness analysis AI, the providing unit uses cross-entropy loss and personalized weighting for each user to continuously improve analysis accuracy. Unlike conventional static effectiveness displays, the providing unit dynamically analyzes effectiveness indicators for each sales text in high-dimensional space and optimizes feedback and improvement suggestions based on non-conventional rules, thereby possessing the technical features required by the McRo precedent. Technical effects of the providing unit include improvement of sales text quality, personalization of user experience, increase in sales conversion rate, and overall system processing efficiency. The providing unit is applicable not only to merchandise platforms but also to various fields requiring effectiveness feedback, such as job advertisement display, tourist information display, and product description display on e-commerce sites.

The receiving unit can allow the user to refer to input from other users when entering product features. For example, the receiving unit displays input from other users for the same brand or category of product, allowing the user to refer to it. Additionally, the receiving unit can automatically suggest distinctive points entered by other users. Furthermore, the receiving unit can provide input templates based on input from other users. As a result, the receiving unit enables the user to input more appealing features by referring to input from other users. Specifically, the receiving unit maintains an input history database for each product, recording information such as brand name, category, distinctive points, input frequency, and input time in chronological order. The receiving unit converts these history data into formats such as categorical vectors (e.g., brand one-hot, category one-hot), frequency count vectors (e.g., occurrence count for each feature word), and time-series arrays (e.g., last 30 entries×10 items), and inputs them into a similar product feature analysis AI module. The receiving unit can utilize clustering algorithms, collaborative filtering models, and BERT-based feature extraction models as the similar product feature analysis AI. As input examples, the receiving unit may receive “Brand: Brand A, Category: sneakers”, “Brand: Brand B, Category: bags”, and as output examples, obtain “Recommended feature candidates: limited color, waterproof function”, “Input template: brand name+condition+features”, etc. Based on the output results of the similar product feature analysis AI, the receiving unit dynamically displays “list of other users' input examples”, “feature candidate suggestions”, and “input template selection button” on the input interface. For training the similar product feature analysis AI, the receiving unit uses cross-entropy loss and data augmentation to continuously improve recommendation accuracy. Unlike conventional static input assistance designs, the receiving unit dynamically analyzes input from other users in high-dimensional space and optimizes input assistance based on non-conventional rules, thereby possessing the technical features required by the McRo precedent. Technical effects of the receiving unit include efficiency of input operations, reduction of input errors, improvement of user experience, supply of high-quality data to the sales text generation AI, and improvement of overall system processing speed. The receiving unit is applicable not only to merchandise platforms but also to various fields requiring input optimization based on other users' history, such as job information input, medical interviews, product registration on e-commerce sites, and customer support history management.

The generation unit can estimate the user's emotion and adjust the tone of the sales text based on the estimated emotion. For example, if the user has a positive emotion, the generation unit generates a sales text with a bright and positive tone. If the user has a negative emotion, the generation unit can generate a sales text with a calm tone. Furthermore, if the user is excited, the generation unit can generate a sales text with an energetic tone. By adjusting the tone of the sales text according to the user's emotion, the generation unit can generate more effective sales texts. Specifically, the generation unit inputs multimodal emotion data obtained from the receiving unit and user operation logs (e.g., input text style, input speed, voice tone, facial images, etc.) into an emotion estimation AI module. The generation unit can use multimodal emotion classification models combining CNN and RNN, or pre-trained large language models with emotion classification heads as the emotion estimation AI. As input examples, the generation unit may receive “Input text: ‘I'm really looking forward to it!’”, “Voice: excited tone”, “Face image: smile”, and as output examples, obtain “Emotion label: excited”, “Emotion score: 0.92”, etc. Based on the output results of the emotion estimation AI, the generation unit assigns tone control tokens or parameters (e.g., positive, calm, energetic, etc.) as conditions to the sales text generation AI (such as Encoder-Decoder type Transformer). For positive state, the generation unit assigns “positive”; for negative state, “calm”; for excited state, “energetic”; and controls the sales text generation AI to sequentially generate output token sequences (e.g., up to 512 tokens) in the corresponding tone. As generation examples, the generation unit outputs “positive: ‘This is a special opportunity just for now!’”, “calm: ‘You can use it in a calm atmosphere’”, “energetic: ‘Supports your energetic daily life!’”, etc. The generation unit evaluates whether the tone of the generated text matches the emotion estimation result using BLEU scores or tone classifiers, and can perform threshold judgment or regeneration processing. These processes are executed rapidly on parallel computation clusters using GPUs, achieving significant improvements in processing speed and personalization accuracy compared to conventional manual tone adjustment. In the process of sales text generation, the generation unit dynamically learns tone control according to emotional state in high-dimensional space and adopts non-conventional and algorithmic generation methods, thereby possessing the technical features required by the McRo precedent. Technical effects of the generation unit include personalization of sales text, improvement of user satisfaction, increase in sales conversion rate, expansion of expression diversity, and overall system processing efficiency. The generation unit is applicable not only to merchandise platforms but also to various fields requiring tone control according to emotion and situation, such as job advertisement texts, tourist information texts, and product description texts for e-commerce sites.

When the user reviews the generated sales text, the providing unit can display feedback from other users. For example, the providing unit displays evaluations and comments from other users for the same product, allowing the user to refer to them. Additionally, the providing unit can display what modifications other users have made. Furthermore, the providing unit can propose improvements to the sales text based on feedback from other users. As a result, the providing unit enables the user to create more appealing sales texts by referring to feedback from other users. Specifically, the providing unit maintains a feedback history database for each product, recording information such as evaluation scores, comment content, modification history, improvement suggestions, and feedback time in chronological order. The providing unit converts these feedback data into formats such as categorical vectors (e.g., rating one-hot), numerical vectors (e.g., score, number of modifications), and text vectors (e.g., comment embeddings), and inputs them into a feedback analysis AI module. The providing unit can utilize Transformer-based text classification models and clustering algorithms as the feedback analysis AI. As input examples, the providing unit may receive “Rating: 4”, “Comment: ‘Please emphasize the title more’”, “Modification: added feature description”, and as output examples, obtain “Recommended improvement: emphasize title”, “Other user modification example: added feature description”, etc. Based on the output results of the feedback analysis AI, the providing unit dynamically displays “list of other users' evaluations and comments”, “modification history summary”, and “suggested improvements” on the sales text display interface. For training the feedback analysis AI, the providing unit uses cross-entropy loss and personalized weighting for each user to continuously improve analysis accuracy. Unlike conventional static feedback display designs, the providing unit dynamically analyzes feedback from other users in high-dimensional space and optimizes display content and improvement suggestions based on non-conventional rules, thereby possessing the technical features required by the McRo precedent. Technical effects of the providing unit include improvement of sales text quality, personalization of user experience, increase in sales conversion rate, and overall system processing efficiency. The providing unit is applicable not only to merchandise platforms but also to various fields requiring feedback from other users, such as job advertisement display, tourist information display, and product description display on e-commerce sites.

The receiving unit can incorporate game elements when the user inputs product features. For example, the receiving unit awards points for features entered by the user and provides benefits when a certain number of points are earned. Additionally, the receiving unit can award badges or titles for features entered by the user. Furthermore, the receiving unit can provide a ranking function that allows users to compete with others. As a result, the receiving unit enables users to enjoy entering product features and increases their motivation to input. Specifically, the receiving unit evaluates the user's input content, input frequency, and input quality (e.g., diversity of feature words, level of detail, few input errors, etc.) in real time, and calculates gamification indicators such as point scores, badge acquisition status, and ranking position. The receiving unit manages these indicators in formats such as numerical vectors (e.g., point score), categorical vectors (e.g., badge type one-hot), and ranking arrays (e.g., top 10 user IDs and scores). As the gamification AI module, the receiving unit can utilize classification models that automatically evaluate the diversity and quality of input content, and ranking aggregation algorithms. As input examples, the receiving unit may receive “Number of features entered: 10”, “Input quality score: 0.95”, “Input errors: 0”, and as output examples, obtain “Points earned: 100”, “Badge: Gold”, “Ranking position: 3rd”, etc. Based on the output results of the gamification AI, the receiving unit dynamically displays “point display”, “badge acquisition notification”, and “ranking board” on the input interface to increase user motivation for input. For training the gamification AI, the receiving unit uses cross-entropy loss and personalized weighting for each user to continuously improve evaluation accuracy. Unlike conventional static input designs, the receiving unit dynamically evaluates the diversity and quality of input content in high-dimensional space and optimizes gamification elements based on non-conventional rules, thereby possessing the technical features required by the McRo precedent. Technical effects of the receiving unit include efficiency of input operations, improvement of input quality, personalization of user experience, and overall system processing efficiency. The receiving unit is applicable not only to merchandise platforms but also to various fields requiring gamification elements, such as job information input, medical interviews, product registration on e-commerce sites, and educational survey input.

The generation unit can estimate the user's emotion and personalize the content of the sales text based on the estimated emotion. For example, if the user is moved, the generation unit generates a sales text including an emotional episode. If the user is excited, the generation unit can generate a sales text including expressions that enhance excitement. Furthermore, if the user is relaxed, the generation unit can generate a sales text conveying a relaxed atmosphere. By personalizing the content of the sales text according to the user's emotion, the generation unit can generate more effective sales texts. Specifically, the generation unit inputs multimodal emotion data obtained from the receiving unit and user operation logs (e.g., input text style, input speed, voice tone, facial images, etc.) into an emotion estimation AI module. The generation unit can use multimodal emotion classification models combining CNN and RNN, or pre-trained large language models with emotion classification heads as the emotion estimation AI. As input examples, the generation unit may receive “Input text: ‘I was very moved’”, “Voice: tearful voice”, “Face image: teary eyes”, and as output examples, obtain “Emotion label: moved”, “Emotion score: 0.95”, etc. Based on the output results of the emotion estimation AI, the generation unit assigns content control tokens or parameters (e.g., emotional, exciting, relaxing, etc.) as conditions to the sales text generation AI (such as Encoder-Decoder type Transformer). For moved state, the generation unit assigns “emotional”; for excited state, “exciting”; for relaxed state, “relaxing”; and controls the sales text generation AI to sequentially generate output token sequences (e.g., up to 512 tokens) in the corresponding content. As generation examples, the generation unit outputs “emotional: ‘This product is filled with moving episodes’”, “exciting: ‘You can't stop the excitement with this limited edition model!’”, “relaxing: ‘A gentle companion for your daily life’”, etc. The generation unit evaluates whether the content of the generated text matches the emotion estimation result using BLEU scores or content classifiers, and can perform threshold judgment or regeneration processing. These processes are executed rapidly on parallel computation clusters using GPUs, achieving significant improvements in processing speed and personalization accuracy compared to conventional manual content adjustment. In the process of sales text generation, the generation unit dynamically learns content control according to emotional state in high-dimensional space and adopts non-conventional and algorithmic generation methods, thereby possessing the technical features required by the McRo precedent. Technical effects of the generation unit include personalization of sales text, improvement of user satisfaction, increase in sales conversion rate, expansion of expression diversity, and overall system processing efficiency. The generation unit is applicable not only to merchandise platforms but also to various fields requiring content personalization according to emotion and situation, such as job advertisement texts, tourist information texts, and product description texts for e-commerce sites.

When the user reviews the generated sales text, the providing unit can provide visual feedback. For example, the providing unit visually emphasizes each part of the sales text using color coding or icons. Additionally, the providing unit can display the effectiveness of the sales text using graphs or charts. Furthermore, the providing unit can highlight the parts modified by the user. As a result, the providing unit enables the user to create more effective sales texts by receiving visual feedback. Specifically, the providing unit has a function to color-code or display icons for each section of the sales text (e.g., title, features, condition, recommended points, etc.), and to emphasize them according to importance or modification history. The providing unit visualizes effectiveness indicators of the sales text (e.g., number of views, clicks, purchases, dwell time, etc.) in real time as graphs or charts, allowing the user to grasp effectiveness at a glance. The providing unit highlights the parts modified by the user, enabling comparison of content before and after modification and version management. The providing unit can manage these visual feedback data in formats such as numerical vectors (e.g., effectiveness indicators), categorical vectors (e.g., modified parts one-hot), and image data (e.g., graph images), and input them into a feedback analysis AI module. The providing unit can utilize anomaly detection models for effectiveness indicators and modification trend clustering models as the feedback analysis AI. As input examples, the providing unit may receive “Modified part: title”, “Effectiveness indicator: increase in clicks”, and as output examples, obtain “Recommended emphasis: title”, “Recommended graph display: click trend”, etc. The providing unit personalizes the content and display method of visual feedback for each user, optimizing the display interface. Unlike conventional static display designs, the providing unit dynamically analyzes user operation history and effectiveness indicators in high-dimensional space and optimizes visual feedback based on non-conventional rules, thereby possessing the technical features required by the McRo precedent. Technical effects of the providing unit include improvement of sales text quality, personalization of user experience, increase in sales conversion rate, and overall system processing efficiency. The providing unit is applicable not only to merchandise platforms but also to various fields requiring visual feedback, such as job advertisement display, tourist information display, and product description display on e-commerce sites.

The receiving unit can estimate the user's emotion and customize the input interface based on the estimated emotion. For example, if the user is relaxed, the receiving unit provides a simple and calm interface design. If the user is excited, the receiving unit can provide a colorful and dynamic interface design. Furthermore, if the user is stressed, the receiving unit can provide an intuitive and easy-to-use interface. By customizing the input interface according to the user's emotion, the receiving unit can provide a more comfortable input experience. Specifically, the receiving unit collects multimodal data obtained from the user's input operations and browsing behavior in real time (e.g., input text style, input speed, voice tone, facial expression features from face images, mouse movements, click frequency, scroll speed, etc.). The receiving unit converts these data into formats such as time-series tensors (e.g., 100 frames×20 features), voice spectrograms (e.g., 40 dimensions×100 frames), and image feature vectors (e.g., 512 dimensions), and inputs them into an emotion estimation AI module. The receiving unit can use multimodal emotion classification models combining CNN and RNN, or pre-trained large language models with emotion classification heads as the emotion estimation AI. As input examples, the receiving unit may receive “Input text: ‘I'm taking it easy today’”, “Voice: calm tone”, “Face image: smile”, and as output examples, obtain “Emotion label: relaxed”, “Emotion score: 0.88”, etc. Based on the output results of the emotion estimation AI, the receiving unit dynamically controls the color scheme, layout, animation effects, number and arrangement of input fields, and presence or absence of help displays in the input interface. For example, in a relaxed state, the receiving unit applies “simple color scheme”, “calm font”, and “minimal input fields”; in an excited state, “colorful color scheme”, “dynamic animations”, and “emphasis display”; and in a stressed state, “intuitive navigation”, “input error detection and correction guidance”, and “always-on help button”. The receiving unit uses the output of the emotion estimation AI for threshold judgment (e.g., simple mode for relaxation score of 0.8 or higher) and branching processing (e.g., emphasize help in stressed state), providing an optimized input experience for each user. For training the emotion estimation AI, the receiving unit uses cross-entropy loss and multimodal data augmentation to continuously improve estimation accuracy. Unlike conventional static interface designs, the receiving unit dynamically estimates the user's psychological state in high-dimensional space and optimizes the interface based on non-conventional rules, thereby possessing the technical features required by the McRo precedent. Technical effects of the receiving unit include personalization of user experience, efficiency of input operations, reduction of input errors, and overall system processing efficiency. The receiving unit is applicable not only to merchandise platforms but also to various fields requiring interface optimization according to emotion, such as job information input, medical interviews, product registration on e-commerce sites, and educational survey input.

The following is a brief explanation of the processing flow of Example of the Embodiment. Specifically, the system comprises multiple modules, including a receiving unit for user input of product features, a feature extraction unit for converting input data into multidimensional feature vectors, a generation AI unit for generating sales text, a sales text optimization unit for optimizing the quality and diversity of generated text, and a providing unit for displaying, editing, and collecting feedback on the sales text for the user. The system accepts multimodal input such as text, images, and voice in the receiving unit, performs one-hot encoding, embedding vectorization, and feature extraction using AI models such as CNN and RNN in the feature extraction unit, and integrates the data for input to the generation AI unit (e.g., Encoder-Decoder type Transformer). The system uses a large language model fine-tuned for sales text generation tasks to sequentially generate output token sequences (e.g., up to 512 tokens) conditioned on the input feature vectors. The sales text optimization unit calculates BLEU scores, self-attention weight distributions, similarity scores, etc., and performs threshold judgment and regeneration processing. The providing unit presents the generated text to the user, enables inline editing, collects feedback, manages modification history, and displays effectiveness indicators in real time. All these processes are executed rapidly on parallel computation clusters using GPUs, achieving significant improvements in processing speed and accuracy compared to conventional manual sales text creation. In the process of sales text generation, the system dynamically learns input features, user attributes, emotional states, history, device information, social media activity, etc., in high-dimensional space, and adopts non-conventional and algorithmic generation, optimization, and display methods, thereby possessing the technical features required by the McRo precedent. Technical effects of the system include reduction of human costs through automation of sales text generation, uniformity of sales text quality, diversification of expressions, personalization for each user, improvement of sales conversion rate, efficiency of database management, and optimization of communication load. The system is applicable not only to merchandise platforms but also to various fields requiring text generation, such as real estate introduction texts, job advertisement texts, tourist information texts, and product description texts for e-commerce sites.

Step 1: The receiving unit provides an interface for the user to input product features. For example, the receiving unit receives information such as product brand name, condition, period of use, and distinctive points. The receiving unit transmits the information entered by the user to the generation unit. Step 2: The generation unit uses a generation AI to analyze the information received from the receiving unit and generate a sales text to highlight the appeal of the product. The generation AI, for example, generates attractive expressions and original sentences based on the product features. The generation unit transmits the generated sales text to the providing unit. Step 3: The providing unit provides the sales text transmitted from the generation unit to the user. For example, the providing unit displays the generated sales text to the user and provides an interface that allows the user to review and, if necessary, make modifications. Specifically, in Step 1, the system receives product feature information (brand name, condition, period of use, distinctive points, etc. as text data, image data, and voice data) in the receiving unit via text input fields, pull-down menus, checkboxes, voice input buttons, and image upload functions on the user interface. The system vectorizes the information received in the receiving unit in the feature extraction unit, converting brand name to one-hot encoding, condition to categorical variables, period of use to numerical scalars, and distinctive points to TF-IDF vectors or embedding vectors, resulting in multidimensional feature vectors (e.g., 128 to 1024 dimensions). If image data is input, the system automatically extracts brand logos and product condition using image recognition models such as CNN; if voice data is input, the system transcribes it using speech recognition models. The system integrates these diverse feature vectors and inputs them into the generation AI unit (e.g., a pre-trained large language model or Encoder-Decoder type Transformer). In the generation AI unit, the system uses a model fine-tuned for sales text generation tasks, conditioned on the input vectors, to sequentially generate output token sequences (e.g., up to 512 tokens) for the sales text. The output of the generation AI unit includes the sales text (e.g., “This product is . . . ”) and scores for evaluating diversity and originality of expression in the sales text optimization unit (e.g., BLEU score, self-attention weight distribution, similarity score, etc.), and performs threshold judgment and regeneration processing. The final sales text is presented to the user in the providing unit, and if the user makes modifications, the modification content is accumulated as retraining data. All these processes are executed rapidly on parallel computation clusters using GPUs, achieving significant improvements in processing speed and accuracy compared to conventional manual sales text creation. In the process of sales text generation, the system dynamically learns combinations of input features and contextual dependencies in high-dimensional space, and adopts non-conventional and algorithmic generation methods, differing from conventional rule-based processing and human intuitive judgment, thereby possessing the technical features required by the McRo precedent. Technical effects of the system include not only reduction of human costs through automation of sales text generation, but also uniformity of sales text quality, diversification of expressions, personalization for each user, improvement of platform-wide sales conversion rate, efficiency of database management, and optimization of communication load. The system is applicable not only to merchandise platforms but also to various fields requiring text generation, such as real estate introduction texts, job advertisement texts, tourist information texts, and product description texts for e-commerce sites.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT® (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned receiving unit, generation unit, and providing unit is implemented by at least one of, for example, the smart device 14 and the data processing apparatus 12. For example, the receiving unit is implemented by a receiving device 38 of the smart device 14 and provides an interface for the user to input product features. The generation unit is implemented, for example, by a specific processing unit 290 of the data processing apparatus 12 and generates a sales text for highlighting the appeal of the product using a generation AI. The providing unit is implemented, for example, by an output device 40 of the smart device 14 and provides the generated sales text to the user. The correspondence between each unit and the device or control unit is not limited to the examples described above and various modifications are possible.

### Second Embodiment

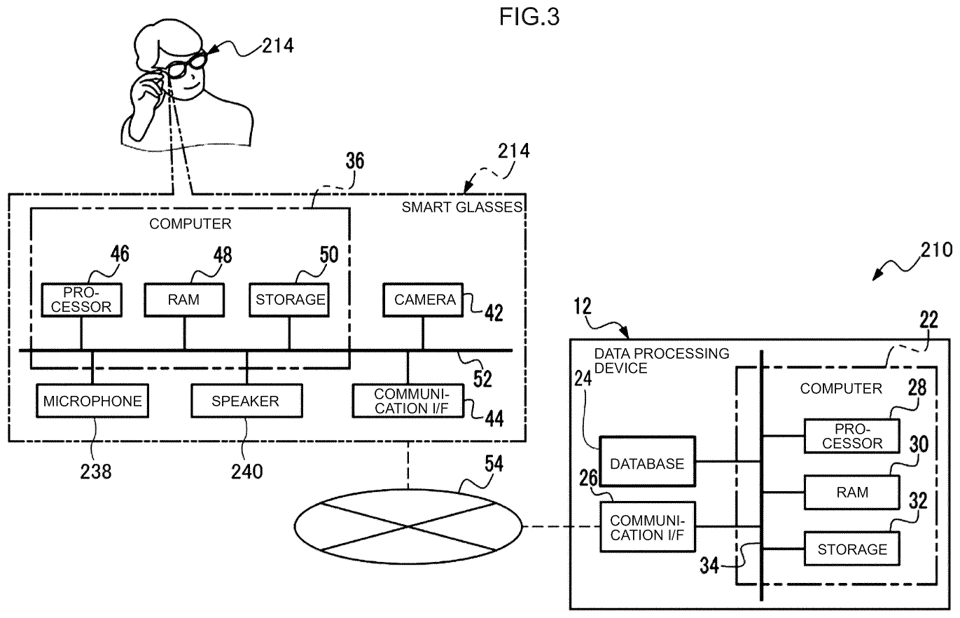

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

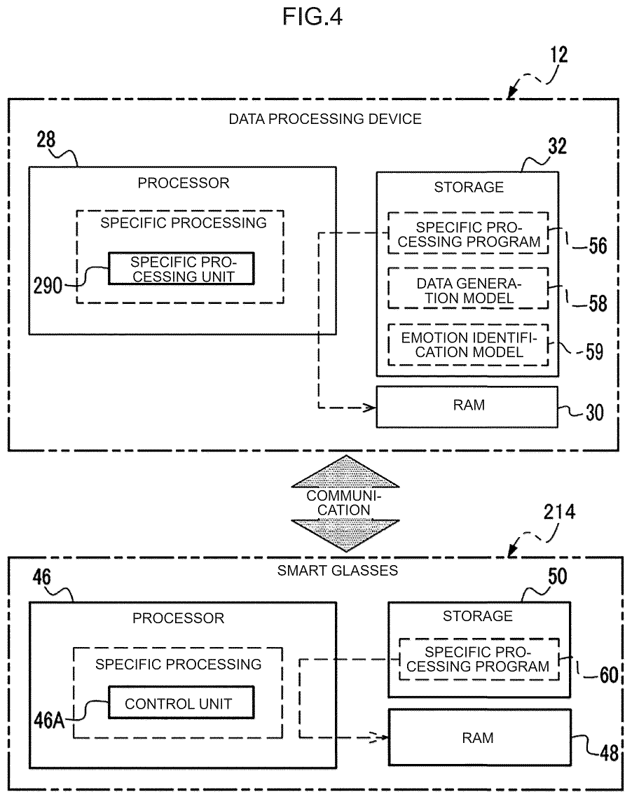

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned receiving unit, generation unit, and providing unit is implemented by at least one of, for example, the smart glasses 214 and the data processing apparatus 12. For example, the receiving unit is implemented by a microphone 238 of the smart glasses 214 and provides an interface for the user to input product features. The generation unit is implemented, for example, by a specific processing unit 290 of the data processing apparatus 12 and generates a sales text for highlighting the appeal of the product using a generation AI. The providing unit is implemented, for example, by a speaker 240 of the smart glasses 214 and provides the generated sales text to the user. The correspondence between each unit and the device or control unit is not limited to the examples described above and various modifications are possible.

### Third Embodiment

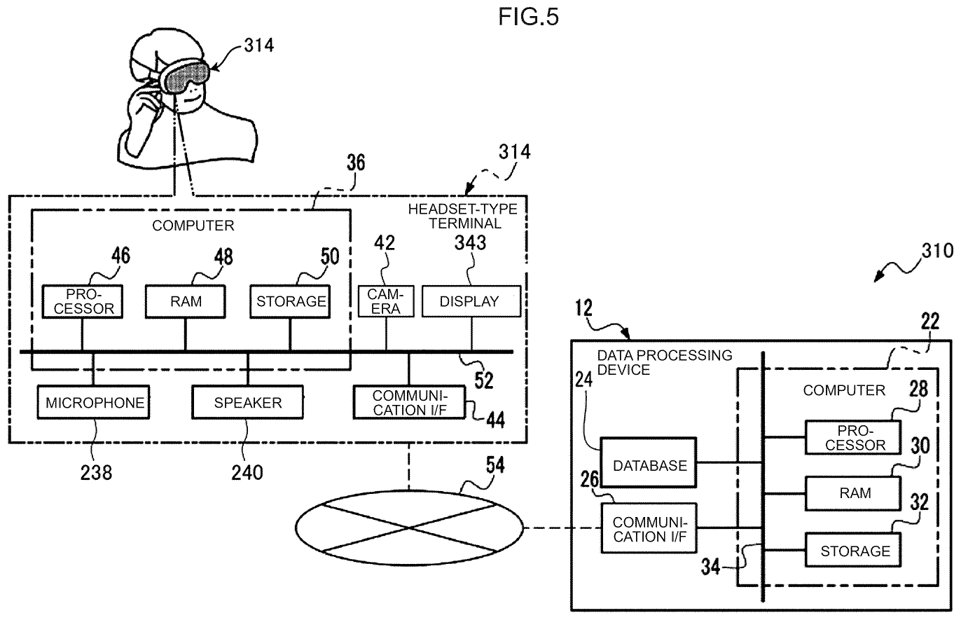

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

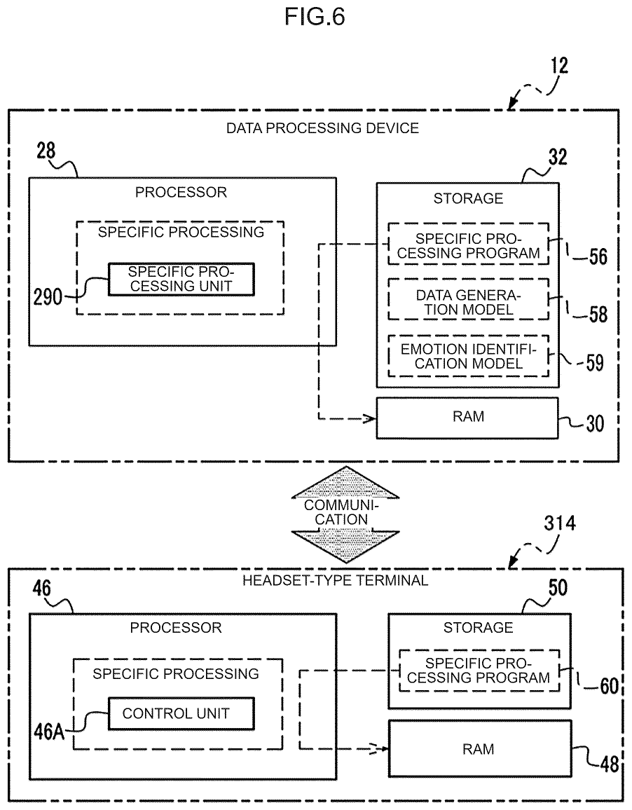

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned receiving unit, generation unit, and providing unit is implemented by at least one of, for example, the headset-type terminal 314 and the data processing apparatus 12. For example, the receiving unit is implemented by a microphone 238 of the headset-type terminal 314 and provides an interface for the user to input product features. The generation unit is implemented, for example, by a specific processing unit 290 of the data processing apparatus 12 and generates a sales text for highlighting the appeal of the product using a generation AI. The providing unit is implemented, for example, by a display 343 of the headset-type terminal 314 and provides the generated sales text to the user. The correspondence between each unit and the device or control unit is not limited to the examples described above and various modifications are possible.

### Fourth Embodiment

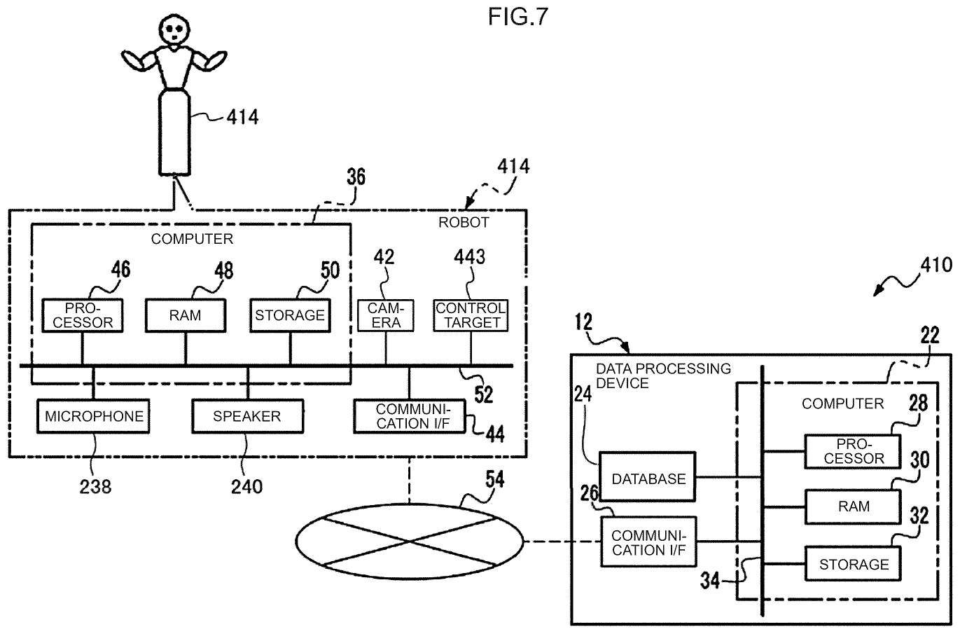

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

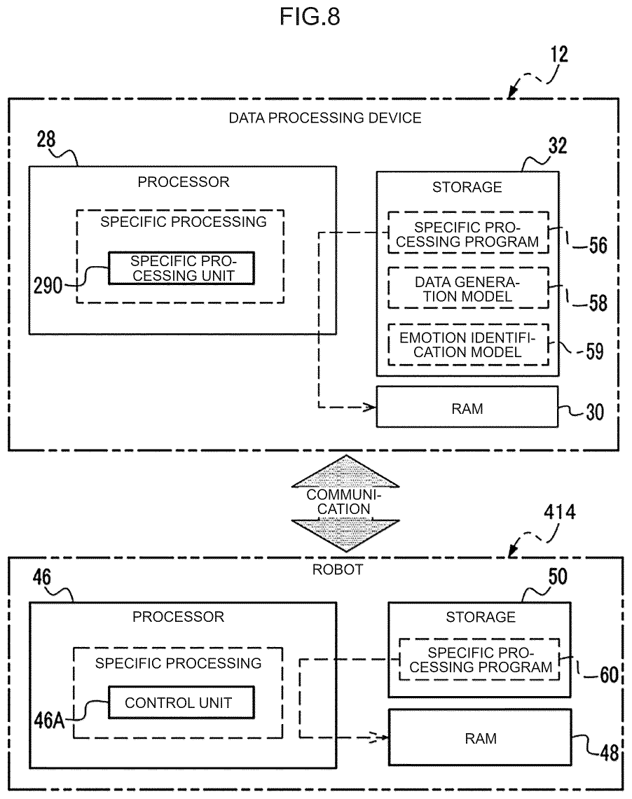

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned receiving unit, generation unit, and providing unit is implemented by at least one of, for example, the robot 414 and the data processing apparatus 12. For example, the receiving unit is implemented by a microphone 238 of the robot 414 and provides an interface for the user to input product features. The generation unit is implemented, for example, by a specific processing unit 290 of the data processing apparatus 12 and generates a sales text for highlighting the appeal of the product using a generation AI. The providing unit is implemented, for example, by a speaker 240 of the robot 414 and provides the generated sales text to the user. The correspondence between each unit and the device or control unit is not limited to the examples described above and various modifications are possible.

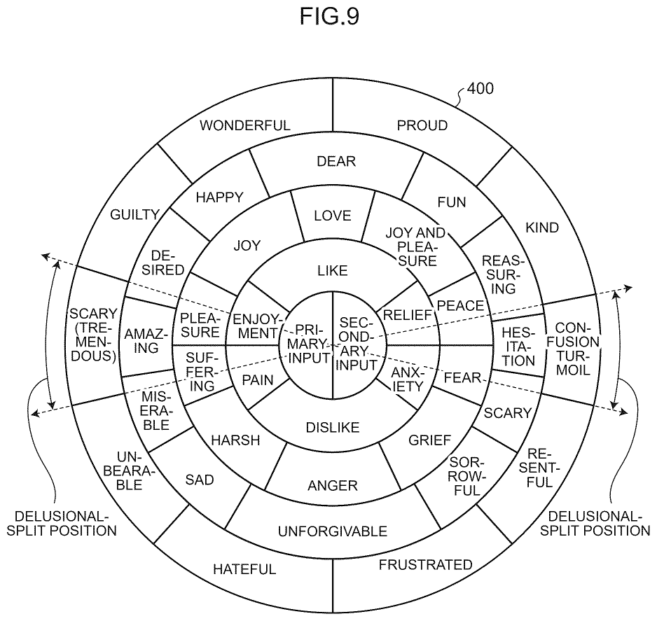

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

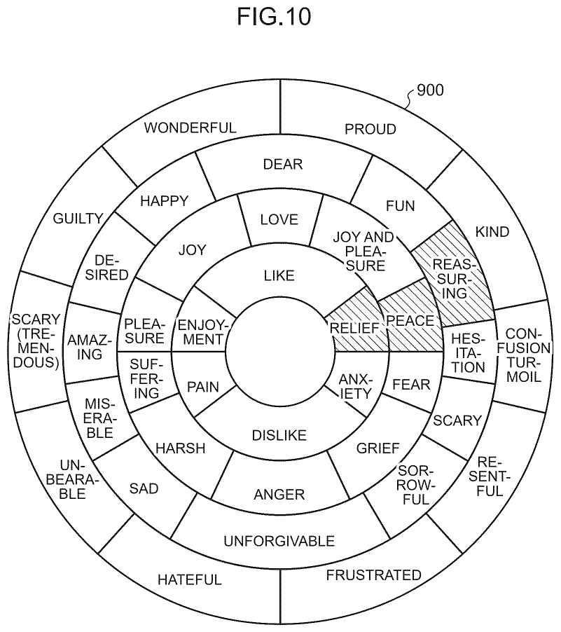

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a receiving unit configured to receive input of product features; a generation unit configured to analyze information received by the receiving unit and generate a sales text for highlighting the appeal of the product; and a providing unit configured to provide the sales text generated by the generation unit to a user.
(Supplementary Note 2) The system according to Supplementary Note 1, wherein the receiving unit is configured to receive information on a product's brand name, condition, period of use, and distinctive points.
(Supplementary Note 3) The system according to Supplementary Note 1, wherein the generation unit is configured to generate expressions and original sentences based on the product features.
(Supplementary Note 4) The system according to Supplementary Note 1, wherein the providing unit is configured to provide the generated sales text to the user and allow the user to make modifications.
(Supplementary Note 5) The system according to Supplementary Note 1, wherein the receiving unit is configured to estimate the user's emotion and adjust the timing of product feature input based on the estimated emotion.
(Supplementary Note 6) The system according to Supplementary Note 1, wherein the receiving unit is configured to analyze the user's past input history and propose an appropriate input method.
(Supplementary Note 7) The system according to Supplementary Note 1, wherein the receiving unit is configured to customize input items based on the user's current area of interest or purchase history when inputting product features.
(Supplementary Note 8) The system according to Supplementary Note 1, wherein the receiving unit is configured to estimate the user's emotion and determine the priority of products to be input based on the estimated emotion of the user.
(Supplementary Note 9) The system according to Supplementary Note 1, wherein the receiving unit is configured to prioritize input of relevant features based on the user's geographic location information when inputting product features.
(Supplementary Note 10) The system according to Supplementary Note 1, wherein the receiving unit is configured to prompt input of relevant features based on the user's social media activity when inputting product features.
(Supplementary Note 11) The system according to Supplementary Note 1, wherein the generation unit is configured to estimate the user's emotion and adjust the expression method of the sales text based on the estimated emotion of the user.
(Supplementary Note 12) The system according to Supplementary Note 1, wherein the generation unit is configured to adjust the level of detail of the sales text based on the importance of the product when generating the sales text.
(Supplementary Note 13) The system according to Supplementary Note 1, wherein the generation unit is configured to apply different generation algorithms according to the type of product when generating the sales text.
(Supplementary Note 14) The system according to Supplementary Note 1, wherein the generation unit is configured to estimate the user's emotion and adjust the length of the sales text based on the estimated emotion of the user.
(Supplementary Note 15) The system according to Supplementary Note 1, wherein the generation unit is configured to determine the priority of the sales text according to the submission timing of the product when generating the sales text.
(Supplementary Note 16) The system according to Supplementary Note 1, wherein the generation unit is configured to adjust the order of the sales text according to the relevance of the product when generating the sales text.
(Supplementary Note 17) The system according to Supplementary Note 1, wherein the providing unit is configured to estimate the user's emotion and adjust the display method of the sales text based on the estimated emotion of the user.
(Supplementary Note 18) The system according to Supplementary Note 1, wherein the providing unit is configured to select an optimal display method by referring to the user's past modification history when providing the sales text.
(Supplementary Note 19) The system according to Supplementary Note 1, wherein the providing unit is configured to add a function to reflect the user's feedback in real time when providing the sales text.
(Supplementary Note 20) The system according to Supplementary Note 1, wherein the providing unit is configured to estimate the user's emotion and adjust the modification procedure of the sales text based on the estimated emotion of the user.
(Supplementary Note 21) The system according to Supplementary Note 1, wherein the providing unit is configured to select an optimal display method by considering the user's device information when providing the sales text.
(Supplementary Note 22) The system according to Supplementary Note 1, wherein the providing unit is configured to analyze the user's social media activity and provide relevant feedback when providing the sales text.

What is claimed is:

1. A system comprising:
circuitry configured to:
receive, from a client terminal via a packet-switched network, attribute data associated with an item;
convert the attribute data into a multidimensional feature vector;
generate an output token sequence by inputting the multidimensional feature vector into a data generation model comprising a neural network; and
transmit the output token sequence to the client terminal via the packet-switched network.

2. The system according to claim 1, wherein the attribute data comprises text data indicating a brand name, a condition, a period of use, and distinctive points of the item.

3. The system according to claim 1, wherein converting the attribute data into the multidimensional feature vector comprises converting the brand name to a one-hot encoding, the condition to a categorical variable, the period of use to a numerical scalar, and the distinctive points to an embedding vector.

4. The system according to claim 1, wherein the multidimensional feature vector has a dimensionality of 128 to 1024 dimensions.

5. The system according to claim 1, wherein the data generation model comprises an encoder-decoder type Transformer fine-tuned for a text generation task.

6. The system according to claim 1, wherein the output token sequence comprises up to 512 tokens.

7. The system according to claim 1, wherein the circuitry is further configured to calculate a quality score for the output token sequence based on at least one of a BLEU score, a self-attention weight distribution, and a similarity score, and regenerate the output token sequence when the quality score falls below a threshold.

8. The system according to claim 1, wherein the attribute data further comprises image data, and the circuitry is further configured to extract an image feature vector from the image data using a convolutional neural network and concatenate the image feature vector with the multidimensional feature vector.

9. The system according to claim 1, wherein the attribute data further comprises audio data, and the circuitry is further configured to convert the audio data into text data using a speech recognition model comprising a recurrent neural network or a Transformer.

10. The system according to claim 1, wherein the circuitry is further configured to:
compute an emotion value by inputting user interaction data into an emotion identification model comprising a classification neural network; and
adjust a generation parameter of the data generation model based on the emotion value.

11. The system according to claim 10, wherein the user interaction data comprises at least one of input text style data, input speed data, voice tone data, and facial expression feature vector data.

12. The system according to claim 10, wherein the generation parameter comprises a style control token selected from a set including a formal token, a casual token, an emphatic token, and a concise token, and the style control token is provided as a condition to the data generation model.

13. The system according to claim 10, wherein the generation parameter comprises a length control token, and the circuitry is configured to control a number of tokens in the output token sequence based on the emotion value.

14. The system according to claim 1, wherein the circuitry is further configured to:
obtain geographic location data from the client terminal; and
adjust the multidimensional feature vector based on a regional trend analysis computed from the geographic location data.

15. The system according to claim 1, wherein the circuitry is further configured to:
retrieve, from a history database, past interaction data associated with a user of the client terminal; and
generate input assistance data based on a time-series prediction model applied to the past interaction data.

16. The system according to claim 1, wherein the circuitry is further configured to generate a target segment vector based on target audience information, and provide the target segment vector as a condition to the data generation model to control a style of the output token sequence.

17. The system according to claim 1, wherein the circuitry is further configured to:
receive modification data from the client terminal indicating user modifications to the output token sequence; and
accumulate the modification data as retraining data for the data generation model.

18. A system comprising:
a communication interface comprising a communication processor and an antenna, the communication interface being connected to a packet-switched network;
a processor;
a random-access memory;
a memory storing a data generation model comprising an encoder-decoder type Transformer and an emotion identification model comprising a classification neural network;
a database; and
circuitry configured to:
receive, from a client terminal via the communication interface and the packet-switched network, attribute data associated with an item, the attribute data comprising at least one of text data, image data, and audio data;
convert the attribute data into a multidimensional feature vector by converting the text data into at least one of a one-hot encoding, a categorical variable, a numerical scalar, and an embedding vector;
when the attribute data comprises image data, extract an image feature vector from the image data using a convolutional neural network and concatenate the image feature vector with the multidimensional feature vector;
compute an emotion value by inputting user interaction data into the emotion identification model;
generate an output token sequence of up to 512 tokens by inputting the multidimensional feature vector and a style control token selected based on the emotion value into the data generation model;
calculate a quality score for the output token sequence based on at least one of a BLEU score, a self-attention weight distribution, and a similarity score;
regenerate the output token sequence when the quality score falls below a threshold; and
transmit the output token sequence to the client terminal via the communication interface and the packet-switched network.

19. The system according to claim 18, wherein the circuitry is further configured to:
store, in the database, past interaction data associated with a user of the client terminal; and
retrieve the past interaction data from the database to generate input assistance data based on a time-series prediction model applied to the past interaction data.

20. A method performed by circuitry of a system, the method comprising:
receiving, from a client terminal via a packet-switched network, attribute data associated with an item;
converting the attribute data into a multidimensional feature vector;
generating an output token sequence by inputting the multidimensional feature vector into a data generation model comprising a neural network; and
transmitting the output token sequence to the client terminal via the packet-switched network.
